(19) United States
(12) Patent Application Publication
(10) Pub. No.: US 2009/0279800 A1
(43) Pub. Date: Nov. 12, 2009

(54) IMAGE COMPRESSION APPARATUS, IMAGE EXPANSION APPARATUS, AND IMAGE PROCESSING APPARATUS

(75) Inventors: Yoshiharu Uetani, Kanagawa (JP); Chatree Budsabathon, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/428,537

(22) Filed: Apr. 23, 2009

(30) Foreign Application Priority Data
May 9, 2008 (JP) 2008-123756

(51) Int. Cl. G06K 9/36

(52) U.S. Cl. 382/238

(57) ABSTRACT

An input pixel valid-bit-number setting unit sets an input pixel valid-bit-number which is the number of gradations of input pixel data. A predictive pixel value generating unit refers to the higher-order bits of earlier already-input pixel data to generate a predictive pixel value for the higher-order bits of a new input pixel. A prediction error group detecting unit detects a prediction error group indicative of the magnitude range of a difference between the predictive pixel value and the value of the higher-order bits of the new input pixel. A prediction error encoding unit multiplexes variable-length encoded information indicative of the prediction error group, overhead bits indicative of a specific value within the prediction error group, and the lower-order bits of the input pixel appropriate for the input pixel valid-bit-number.

### CROSS-REFERENCE TO RELATED APPLICATIONS

This application is based upon and claims the benefit of priority from the prior Japanese Patent Application No. 2008-123756 filed in Japan on May 9, 2008; the entire contents of which are incorporated herein by reference.

### BACKGROUND OF THE INVENTION

1. Field of the Invention

The present invention relates to an image compression apparatus, an image expansion apparatus and an image processing apparatus and, more particularly, to an image compression apparatus, an image expansion apparatus and an image processing apparatus capable of encoding images having various numbers of gradations (different numbers of pixel bits) by common encoding means using no more than a predetermined code quantity.

2. Description of the Related Art

Conventionally, differential pulse code modulation (DPCM) has been used that encodes a difference between an input value and a predictive value (referred to as a prediction error) as a method of reversible encoding (lossless compression) or as a method of irreversible encoding near reversible encoding (near-lossless compression).

Since a code quantity greatly differs depending on the type of images in the case of lossless compression, the code quantity is controlled by switching a numerical loss level (between reversible encoding and irreversible encoding) for each region of a plurality of pixels in a system that requires code quantity restrictions (see, for example, Japanese Patent No. 3749752).

However, since the numerical loss level is in units of regions, each of which is composed a plurality of pixels, in the case of Japanese Patent No. 3749752, the compression ratio is low and a large code quantity is consumed due to encoding settings near lossless compression for a partial large brightness variation within a region with less frequent brightness variation (since prediction error is small in this region, the region is switched and set to lossless compression having a low compression ratio and a high degree of decompressibility). On the other hand, a decompression loss occurs and, therefore, a visual image degradation takes place due to irreversible encoding settings for a partial small brightness variation within a region with more frequent brightness variation (since prediction error is large in this region, the region is switched and set to lossy compression having a high compression ratio). In addition, encoding of loss level information on those regions is required on a region-by-region basis, thus causing a degradation in encoding efficiency. Furthermore, there is a need for quantization or a preparation of code tables appropriate for those numbers of gradations, in order to cope with image data having various numbers of gradations (numbers of pixel bits). This necessity causes an increase in a circuit scale and a decrease in processing speed.

### BRIEF SUMMARY OF THE INVENTION

According to one aspect of the present invention, there is provided an image compression apparatus including: a setting unit configured to set an input pixel valid-bit-number; a predictive pixel value generating unit configured to refer to a plurality of higher-order bits of earlier already-input pixel data to generate a predictive pixel value for a plurality of higher-order bits of a new input pixel; a prediction error group detecting unit configured to detect a prediction error group indicative of the magnitude range of a difference between the predictive pixel value and a value of the plurality of higher-order bits of the new input pixel; a prediction error encoding unit configured to multiplex variable-length-encoded information indicative of the prediction error group, overhead bits indicative of a specific value within the prediction error group, and lower-order input pixel bits appropriate for the input pixel valid-bit-number; and a packing unit configured to output data multiplexed by the prediction error encoding unit in units of a predetermined number of bits.

According to another aspect of the present invention, there is provided an image expansion apparatus including: a setting unit configured to set an output pixel valid-bit-number; an encoded data loading unit configured to load the variable-length code of a prediction error group indicative of the magnitude range of a prediction error, overhead bits indicative of the value of the prediction error, and data encoded using overhead bits appropriate for the output pixel valid-bit-number; a prediction error decoding unit configured to reproduce lower-order bits appropriate for the prediction error and the output pixel valid-bit-number out of the data loaded by the encoded data loading unit; a predictive pixel value generating unit configured to refer to a plurality of higher-order bits of an earlier already-reproduced pixel to generate a predictive pixel value; and a pixel value reproducing unit configured to add the reproduced prediction error to the predictive pixel value to reproduce the pixel value of a plurality of higher-order bits.

According to yet another aspect of the present invention, there is provided an image processing apparatus including: a pixel compressing unit provided with the above-described image compression apparatus; a pixel expanding unit provided with the above-described image expanding apparatus; and an image processing unit configured to temporarily store an intermediate processing result obtained by processing input image data in external memory through the pixel compressing unit, read a plurality of intermediate processing results stored in the external memory through the pixel expanding unit, and output an image-processed final processing result.

### BRIEF DESCRIPTION OF THE DRAWINGS

FIG. 1 is a block diagram showing an image compression apparatus of a first embodiment of the present invention;

FIG. 2 is a block diagram showing one detailed configuration example of FIG. 1;

FIG. 3 is a characteristic drawing showing the input-output characteristics of the quantizing unit of a target code quantity difference level detecting unit;

FIG. 4 is a block diagram showing a configuration example of a predictive pixel value generating unit in the first embodiment;

FIG. 5 is a block diagram showing another detailed configuration example of FIG. 1;

FIG. 6 is a block diagram showing an image compression apparatus corresponding to the theoretical configuration of the first embodiment of the present invention;

FIG. 7 is a block diagram showing an image expansion apparatus of a second embodiment of the present invention;

FIG. 8 is a block diagram showing one detailed configuration example of FIG. 7;

FIG. 9 is a block diagram showing a configuration example of a predictive pixel value generating unit in the second embodiment;

FIG. 10 is a block diagram showing another detailed configuration example of FIG. 7;

FIG. 11 is a block diagram showing an image expansion apparatus compatible with an image compression apparatus having the theoretical configuration of FIG. 6;

FIG. 12 is a block diagram showing an image compression apparatus of a third embodiment of the present invention;

FIG. 13 is a schematic view used to explain encoded data and correcting data written to memory having the unit of fixed length setting (for example, setting in units of lines) within the image compression apparatus of FIG. 12;

FIG. 14 is a block diagram showing an image expansion apparatus compatible with the image compression apparatus of FIG. 12;

FIG. 15 is a block diagram showing an image processing apparatus of a fourth embodiment of the present invention;

FIG. 16 is a block diagram showing an image compression apparatus of the related art of the present invention; and

FIG. 17 is a block diagram showing an image expansion apparatus of the related art of the present invention.

### DETAILED DESCRIPTION OF THE INVENTION

Now, embodiments of the present invention will be described with reference to the accompanying drawings.

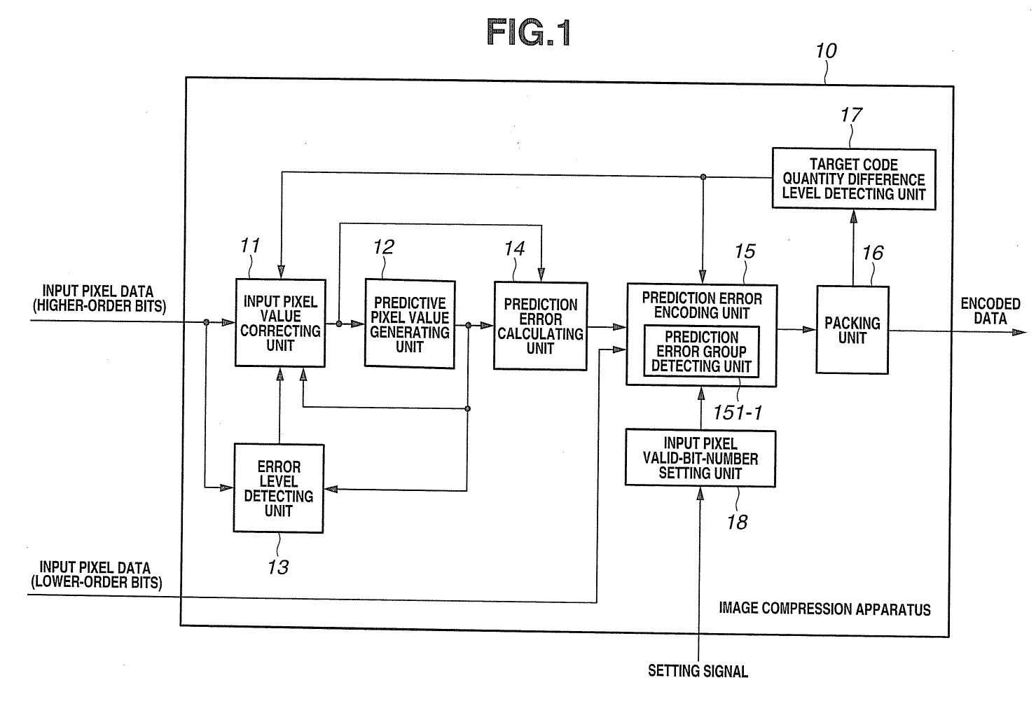

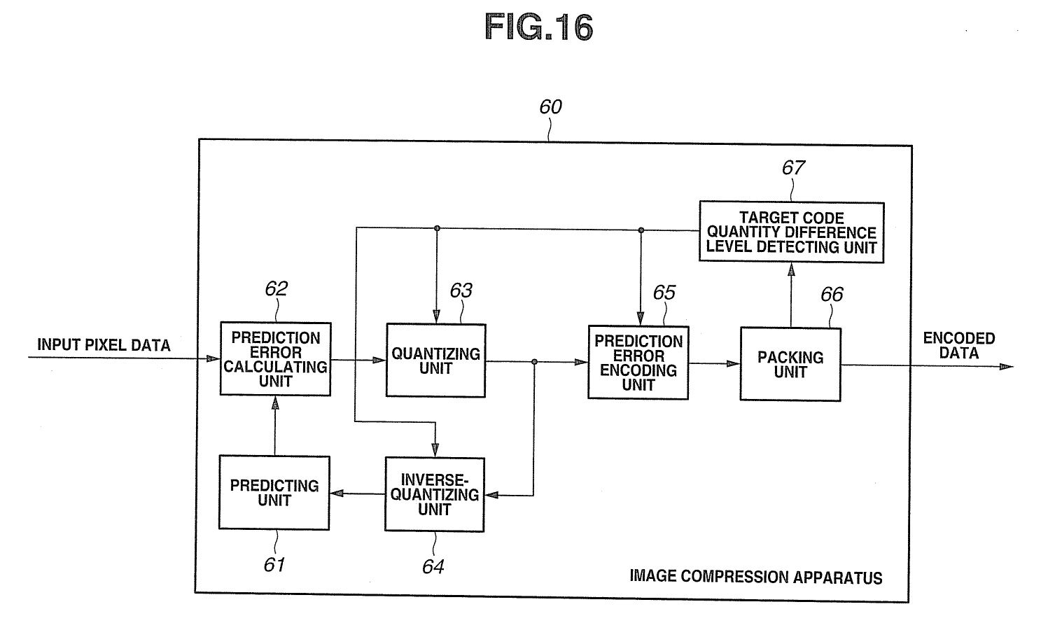

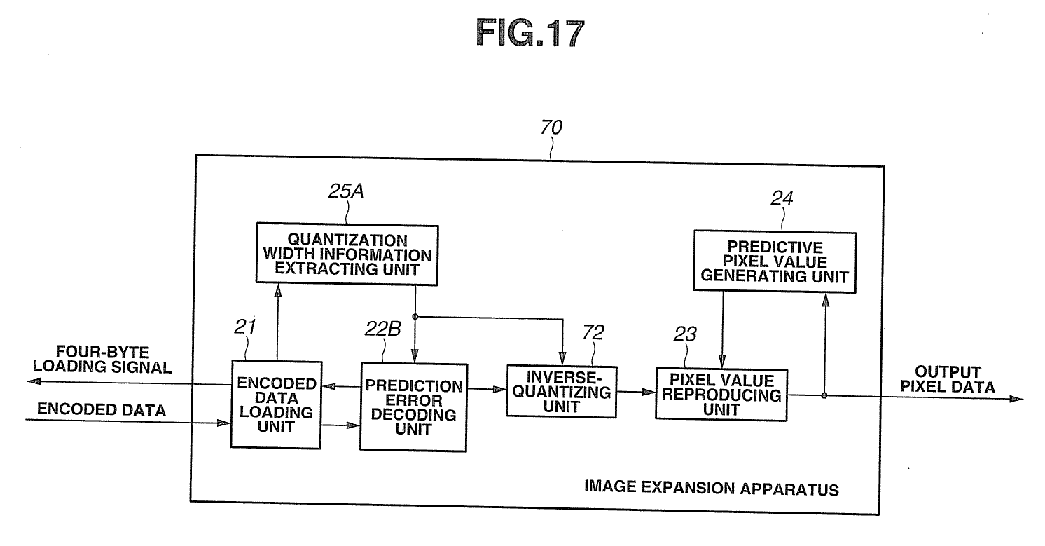

Prior to describing embodiments of the present invention with reference to FIGS. 1 to 15, an explanation will be made of a theoretical related art concerning the present invention by referring to FIGS. 16 and 17.

FIG. 16 shows an image compression apparatus, whereas FIG. 17 shows an image expansion apparatus.

In an image compression apparatus 60 shown in FIG. 16, a prediction error calculating unit 62 calculates a difference (prediction error) between input pixel data (for example, 8 bits) and a predictive pixel value created by a predicting unit 61, quantizes the prediction error by a quantizing unit 63, and sends the quantized prediction error to a prediction error encoding unit 65 to encode the prediction error. In the prediction error calculating unit 62, the resulting difference data is 9-bit data having a i sign bit since prediction data is subtracted from current input pixel data. This 9-bit data is nonlinearly quantized by the quantizing unit 63 and is input to the prediction error encoding unit 65. The encoded data sent from the prediction error encoding unit 65 is packed at a packing unit 66 in units of a predetermined code quantity, and the packed output code quantity is compared with a target code quantity in units of a plurality of pixels (by the unit of quantization width control) at a target code quantity difference level detecting unit 67. The quantizing unit 63 coarsens a quantization width before quantizing the encoded data if the code quantity sent from the packing unit 66 is larger than the target code quantity, and outputs the quantized encoded data to the prediction error encoding unit 65. If the output code quantity is smaller than the target code quantity, the quantizing unit 63 densifies the quantization width before quantizing the encoded data, and outputs the quantized encoded data to the prediction error encoding unit 65. On the other hand, the quantized data quantized by the quantizing unit 63 is also sent to an inverse-quantizing unit 64. The inverse-quantizing unit 64 inverse-quantizes the quantized data to restore the quantized data to data having the number of gradations before quantization. The predicting unit 61 retains (delays) this inverse-quantized data for a one-pixel period to generate predictive pixel data.

A prediction error provided in units of one pixel quantized by the quantizing unit 63 according to a target code quantity difference level provided in units of a plurality of pixels is input to the prediction error encoding unit 65. A variable-length code for the pixel-by-pixel prediction error is generated and output to the packing unit 66.

The packing unit 66 packs and outputs quantization width information provided in units of a plurality of pixels and the variable-length encoded data sent from the prediction error encoding unit 65.

The prediction error encoding unit 65 contains a variable-length code table indicative of variable-length codes appropriate for prediction errors, a comprehensive code length table, and the like. Even if input pixel data having more than 8 bits is input, the prediction error encoding unit 65 is enabled to cope with the data by increasing the number of bits to be dealt with by each of these tables.

On the other hand, in an image expansion apparatus 70 shown in FIG. 17, an encoded data loading unit 21 loads encoded data (including quantization width information) from the image compression apparatus 60 of FIG. 16. A quantization width information extracting unit 25A extracts quantization width information used for the unit of a plurality of pixels from the encoded data.

The variable-length code data output from the encoded data loading unit 21 is input to a prediction error decoding unit 22B, and the prediction error decoding unit 22B reproduces the prediction error and detects the code length thereof. An inverse-quantizing unit 72 inverse-quantizes the prediction error reproduced by the prediction error decoding unit 22B, according to the quantization width information extracted by the quantization width information extracting unit 25A. A predictive pixel value generating unit 24 refers to an earlier already-reproduced pixel and generates a predictive pixel value. A pixel value reproducing unit 23 adds the inverse-quantized (reproduced) prediction error to the predictive pixel value sent from the predictive pixel value generating unit 24 and reproduces a pixel value.

As described above, in the image expansion apparatus 70 in which an encoded prediction error is decoded as is done by the image compression apparatus 60 of FIG. 16, it is possible to reproduce a pixel value in units of a plurality of pixels, with both lossless compression and lossy compression combined, by inverse-quantizing the prediction error according to quantization width information provided in units of a plurality of pixels.

Incidentally, in recent years, such an interface as HDMI (High-Definition Multimedia Interface) has emerged, which is capable of transferring input pixel data in multi-gradation mode and at high speeds. This emergence has brought about a situation that the number of bits of input pixel data is not limited to 8 bits. In the case of television pictures, various numbers of pixel bits larger than 8 bits have been adopted, as exemplified by pixel data composed of 10 bits or 12 bits.

In the below-described embodiments of the present invention, higher-order 8 bits are DPCM-processed and sent as a differential signal (error signal), and additional 2 or 4 bits other than the 8 bits are sent as lower-order bit data without being DPCM-processed, when data of a large number of bits exceeding 8 bits (for example, 10 or 12 bits) is transmitted as input pixel data.

### First Embodiment

FIG. 1 is a block diagram showing an image compression apparatus of a first embodiment of the present invention.

An image compression apparatus 10 shown in FIG. 1 includes: an input pixel valid-bit-number setting unit 18; a predictive pixel value generating unit 12; an error level detecting unit 13; a target code quantity difference level detecting unit 17; an input pixel value correcting unit 11; a prediction error calculating unit 14; a prediction error encoding unit 15; and a packing unit 16.

The input pixel valid-bit-number setting unit 18 is used to set the input pixel valid-bit-number which is the number of gradations (number of pixel bits) of input pixel data.

If the input pixel data is made settable to either 10 bits or 8 bits, the encoding operation of the prediction error encoding unit 15 is changed (switched) and set by a one-bit setting signal (signal used to set the data as 10-bit or 8-bit data) input from unillustrated control means, depending on whether the input pixel valid-bit-number is 10 or 8. If the input pixel data is composed of 10 bits, the input pixel valid-bit-number setting unit 18 sets a value (for example, 1) indicative of the input pixel valid-bit-number of 10. If the input pixel data is composed of 8 bits, the input pixel valid-bit-number setting unit 18 sets a value (for example, 0) indicative of the input pixel valid-bit-number of 8. This setting instruction may be given automatically by detecting the number of bits of the input pixel data or may be given manually according to the number of bits of the input pixel data. If the input pixel valid-bit-number is 10, a predetermined number of higher-order bits (8 bits here), among the 10 input pixel data bits, is referred to as higher-order multiple bits (hereinafter simply referred to as higher-order bits). The higher-order bits are specified as DPCM-processed bits subject to DPCM. The remaining plurality of lower-order bits (2 bits here) are referred to as lower-order multiple bits (hereinafter simply referred to as lower-order bits). The lower-order bits are specified as non-DPCM-processed bits not subject to DPCM.

In other words, if the input pixel data of the image compression apparatus 10 is 10-bit data, the higher-order bits (8 bits) of the 10 bits are DPCM-processed and input to the prediction error encoding unit 15. Concurrently, the remaining lower-order bits (2 bits) are directly input to the prediction error encoding unit 15 without being DPCM-processed. In the prediction error encoding unit 15, the DPCM-processed bit data and the non-DPCM-processed bit data are multiplexed with later-described variable-length coded prediction error group information, and output to the packing unit 16.

Table 1 represents a conversion function provided within the prediction error encoding unit 15, showing an example of a table in which input pixel data is composed of 8 bits. The table shows classification information (hereinafter referred to as prediction error groups) indicative of the magnitude range of prediction errors, overhead bit data indicative of the specific value of each prediction error within the prediction error groups, the binary representations (8 bits) of the prediction errors, and the number of overhead bits.

Table 2 also represents a conversion function provided within the prediction error encoding unit 15, showing an example of a table in which input pixel data is composed of 10 bits. The table shows prediction error groups indicative of the magnitude range of prediction errors, overhead bit data+lower-order bit data for the prediction error groups, binary representations of the prediction error+lower-order bits, and the number of overhead bits+the number of lower-order bits. If the input pixel data is composed of 8 bits, each lower-order 2 bits of data shown in this Table 2 are masked and the number of lower-order bits (2 bits) is subtracted, so that the table is used as Table 1. Table 2 will be described again later when the prediction error encoding unit 15 is explained.

Note that in a case where the input pixel valid-bit-number is set to 8 bits by the input pixel valid-bit-number setting unit 18 and only 8 bits subject to DPCM are input as input pixel data, there takes place the same operation as described in Japanese Patent Application Laid-Open Publication No. 2007-180181 applied for a patent by the applicant of the present application to the Japanese Patent Office on Jul. 9, 2007 (U.S. patent application Ser. No. 12/169847 applied for a patent to the U.S. Patent Office on Jul. 9, 2008). However, an explanation was made of a case, by way of example, in which bits subject to DPCM bits were 10 bits, in a patent application filed prior to this already-filed patent application, showing a configuration in which the input pixel valid-bit-number setting unit 18 and an input line for lower-order bits were not required.

First, an explanation will be made briefly of a case in which input pixel data does not have lower-order 2 bits and only 8 bits are input. In this case, the image compression apparatus is placed in a state in which the input pixel valid-bit-number has been set to 8 by the input pixel valid-bit-number setting unit 18, as described above.

The predictive pixel value generating unit 12 refers to an earlier already-input pixel and generates a predictive pixel value. The error level detecting unit 13 detects the magnitude of a difference between the predictive pixel value and an input pixel value. The target code quantity difference level detecting unit 17 detects a target code quantity difference level indicative of a magnitude by which a generated code quantity for the number of already-encoded pixels exceeds the target code quantity for the number of pixels.

According to an error level output from the error level detecting unit 13 and a target code quantity difference level output from the target code quantity difference level detecting unit 17, the input pixel value correcting unit 11 makes a replacement correction to lower-order bit data within 8 bits of an input pixel value, so that the data is the same as the lower-order bit data of a predictive pixel value output from the predictive pixel value generating unit 12. The term lower-order bit data as used herein refers to bit data on the lower-order side ranging from the lowest-order bit to a bit a certain number of bits upward, among the higher-order bits. By such a replacement correction of input pixel data as described above, it is possible to set the lower-order bit data of a prediction error to 0 in the post-stage prediction error calculating unit 14.

The prediction error calculating unit 14 calculates a prediction error which is a difference between a pixel value output from the input pixel value correcting unit 11 and a predictive pixel value output from the predictive pixel value generating unit 12. The prediction error encoding unit 15 multiplexes and outputs the variable-length coded prediction error group information indicative of the magnitude range of the prediction error and overhead bits indicative of the specific value of a prediction error within the prediction error group as variable-length coded data. The prediction error encoding unit 15 include a prediction error group table (for example, Table 2 (or functionally Table 1)) and a prediction error group detecting unit 151-1 configured to detect a prediction error group indicative of the magnitude range of a difference between the predictive pixel value and a new input pixel value. The packing unit 16 packs and outputs the variable-length encoded data in units of a predetermined code quantity.

The lower-order bit data of the prediction error set to 0 by the above-described correction of input data is excluded from the objects of encoding by the prediction error encoding unit 15 at the time of encoding, before encoding (multiplexing) is performed. That is, data is encoded (multiplexed) with the lower-order bit data of this “0” prediction error deleted without being encoded.

Specifically, if the magnitude of the prediction error is greater than a predetermined value, the prediction error encoding unit 15 excludes the lower-order bit data of the overhead bits of the prediction error from the objects of encoding before encoding (multiplexing) the prediction error, according to the target code quantity difference level. That is, if the magnitude of the prediction error group is greater than a predetermined value and as the target code quantity difference level increases by 1 or more, a determination is made as to how many bits upward from the lowest-order bit of the overhead bits of the prediction error need to be excluded before the prediction error is encoded (multiplexed).

In such an 8-bit example as described above, it is possible realize an image compression apparatus that does not require transmitting information on lossless and lossy compressions (for example, quantization width information), by correcting the input pixel value according to the target code quantity difference level in the image compression apparatus configured to encode the prediction error and performing code quantity control on a pixel-by-pixel basis with lossless and lossy compressions combined only if the prediction error becomes larger than the predetermined value.

Next, under a condition in which the input pixel valid-bit-number is set to 10 and 10 bits are input as input pixel data, the higher-order 8 bits are subjected to DPCM and the lower-order 2 bits are directly sent to the prediction error encoding unit 15 without being subjected to DPCM. In this case, the lower-order 2 bits are sent to the prediction error encoding unit 15 through a separate input line. Hereinafter, an explanation will be made of a case in which the input pixel valid-bit-number is 10.

The predictive pixel value generating unit 12 refers to the higher-order bits of an earlier already-input pixel and generates a predictive pixel value for the higher-order bits of a new input pixel.

The error level detecting unit 13 detects an error level indicative of the magnitude of a difference between the predictive pixel value and the higher-order bit value of the input pixel value.

The target code quantity difference level detecting unit 17 detects a target code quantity difference level indicative of a magnitude by which a generative code quantity for the number of already-encoded pixels exceeds a target code quantity corresponding to the number of pixels.

The input pixel value correcting unit 11 corrects lower-order bit data within the higher-order bits of the input pixel, so that the data is the same as the lower-order bit data of the predictive pixel value, according to the target code quantity difference level, in a case where an error level is greater than a predetermined value. The term lower-order bit data within the higher-order bits as used herein refers to bit data on the lower-order side ranging from the lowest-order bit to a bit a certain number of bits upward, among the higher-order 8 bits.

The prediction error calculating unit 14 calculates the prediction error of the higher-order bits which is a difference between the pixel value output from the input pixel value correcting unit 11 and the predictive pixel value.

The prediction error encoding unit 15 is configured to multiplex the variable-length coded group information of the prediction error group indicative of the magnitude range of the calculated prediction error of the higher-order bits, overhead bits indicative of a specific value of a prediction error among the prediction error group, and lower-order input pixel bits (for example 2 or 4 bits) appropriate for the input pixel valid-bit-number (for example 10 or 12 bits). In a case where the prediction error group is greater than a predetermined value, the prediction error encoding unit 15 excludes some of the lower-order bits (overhead bits of the prediction error of the higher-order bits and lower-order input pixel bits) from the objects of encoding (multiplexing) before encoding the prediction error, according to the target code quantity difference level. The prediction error encoding unit 15 includes a prediction error group table (for example, Table 2 (and Table 1)) and a prediction error group detecting unit 151-1 configured to detect a prediction error group indicative of the magnitude range of a difference between the predictive pixel value and the higher-order bit value of a new input pixel value.

The packing unit 16 packs and outputs the variable-length encoded (multiplexed) data in units of a predetermined code quantity (a predetermined number of bits).

In the first embodiment of FIG. 1 configured as described above, the prediction error encoding unit 15 excludes part of the lower-order bit side (overhead bits of the prediction error of the higher-order bits and lower-order input pixel bits) from the objects of encoding before encoding the prediction error, according to the target code quantity difference level, if the prediction error group is greater than a predetermined value. Specifically, if the value of prediction error group information is smaller than a predetermined value (i.e., the prediction error is smaller than the predetermined value) and the target code quantity difference level is 0, then lossless compression is performed without reducing the lower-order bit side. In contrast, if the value of prediction error group information is larger than the predetermined value (i.e., the prediction error is larger than the predetermined value) and the target code quantity difference level is as high as 1 or higher (1, 2, 3, . . . ), then the lower-order bit side is reduced by as much as the number of bits appropriate for the difference level. Thus, lossy compression is performed.

Consequently, in the image compression apparatus configured to encode the prediction error, it is possible realize an image compression apparatus that does not require transmitting information on lossless and lossy compressions (for example, quantization width information), by correcting the input pixel value according to the target code quantity difference level and performing code quantity control on a pixel-by-pixel basis with lossless and lossy compressions combined only if the prediction error becomes larger than the predetermined value.

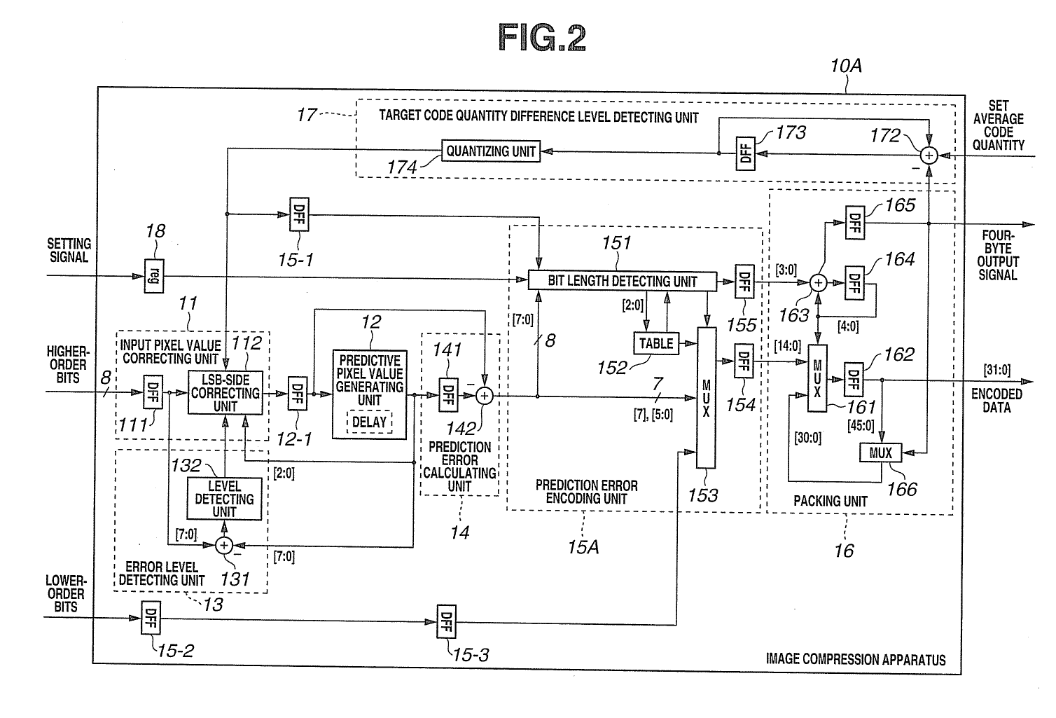

FIG. 2 is a block diagram showing one detailed configuration example of FIG. 1. Components having the same functions as those of FIG. 1 are denoted by like numerals in the description to be made hereinafter.

In an image compression apparatus 10A shown in FIG. 2, an input pixel value correcting unit 11 includes: a D flip-flop (interposed to make the time adjustment of image data, and hereinafter referred to as a DFF) 111, to which one-pixel data composed of a predetermined number of bits (for example, 10 bits the 8 bits of which are higher-order bits and 2 bits of which are lower-order bits) is input and which is configured to cause a one-clock delay; and an LSB (Less Significant Bit)-side correcting unit 112 configured to make a replacement correction to the lower-order bit data of the higher-order bits of the input pixel data from the DFF 111, according to a target code quantity difference level output from the target code quantity difference level detecting unit 17, so that the data is the same as the lower-order bit data of the predictive pixel value from the predictive pixel value generating unit 12, only if an error level output from the error level detecting unit 13 shows a value larger than a predetermined value. The LSB-side correcting unit 112 is, so to speak, a correcting unit configured to correct lower-order bit data, among the higher-order bits of input pixel data. The LSB-side correcting unit 112 does not correct the input pixel data, however, if the target code quantity difference level is 0.

Now, an explanation will be made of the reason that only the lower-order bit data is included in the objects of correction or is excluded from the objects of encoding.

The reason for this is to limit an error only to within an error range in the lower-order bits since the higher-order bits contain important data and, if any error occurs therein, the error is visually recognized as a large error. In addition, if the magnitude of a prediction error is smaller than a predetermined value, the input pixel value correcting unit 11 uses the input pixel data as is, without correction, since an error in parts of data with small changes tends to be recognized visually. If the prediction error is larger than the predetermined value, the input pixel value correcting unit 11 corrects the lower-order bit side data of the input pixel data, according to the target code quantity difference level, so that the lower-order bit side data is the same as the predictive pixel value. That is, if the prediction error is larger than a predetermined value and the target code quantity difference level thereof is low, the input pixel value correcting unit 11 corrects the input pixel data, so that the lowest-order bit data is the same as the lowest-order bit data of a predictive pixel value. As the target code quantity difference level increases, the input pixel value correcting unit 11 corrects the input pixel data so that data second from the lowest-order bit and data third therefrom are successively made to be the same as data in the corresponding bit positions of the predictive pixel value. In this way of correcting input pixel data, it is possible to set all of the lower-order bit side data of the prediction error in the prediction error calculating unit 14 to 0. The lower-order bit side data part of the prediction error set to 0 in this way by the correction of input pixel data is excluded from the objects of encoding by the prediction error encoding unit 15 at the time of encoding before being encoded. That is, data is encoded with the lower-order bit side data part of this “0” prediction error deleted without being encoded (in other words, some of the lowest-order side bits of lower-order bit side data are not encoded but higher-order bits other than these bits are encoded), and is then sent out to the decoding side.

The predictive pixel value generating unit 12 shown in the figure may be configured with a signal line alone, so as to let an input signal pass therethrough as is, without causing a delay, if the unit refers to only one earlier pixel output from a DFF 12-1 configured to cause a one-clock delay in the pre-stage thereof. That is, the predictive pixel value generating unit 12 may be replaced with a signal line alone and a one-clock delay signal (signal one pixel earlier) output from the DFF 12-1 may be used as a predictive pixel value. Alternatively, as shown in FIG. 4, the predictive pixel value generating unit 12 may refer to two earlier pixels, i.e., a one-clock delay signal output by the pre-stage DFF 12-1 and a signal delayed one clock further by another DFF 121 provided in series in the post-stage of the DFF 12-1 (i.e., a signal two pixels earlier, delayed two clocks by the two flip-flops DFF 12-1 and DFF 121). Then, a predictive value may be calculated and generated by a calculating unit 122 using a predetermined predictive pixel value generating function formula “f”. Note that increasing this number of reference pixels further does not depart from the scope of the embodiments of the present invention.

The error level detecting unit 13 includes: an adder 131 configured to find a difference between the higher-order bit value of input pixel data from the DFF 111 and a predictive pixel value from the predictive pixel value generating unit 12; and a level detecting unit 132 configured to output an error level indicative of whether the magnitude of the difference is greater than a predetermined value.

The prediction error calculating unit 14 includes: a DFF 141 configured to cause a one-clock delay in predictive image data output from the predictive pixel value generating unit 12; and an adder 142 configured to calculate a prediction error which is a difference between a higher-order bit value after correction processing in which the output of the input pixel value correcting unit 11 is delayed one clock by the DFF 12-1 and a predictive pixel value is delayed one clock by the DFF 141.

Note that here, the differences dealt with in the above-described error level detecting unit 13 and prediction error calculating unit 14 are treated as a two's complement representation of 8 bits in which overflows due to difference calculations are ignored, since DPCM processing in stages subsequent to the output of the LSB-side correcting unit 112 is reversible processing.

Table 1 represents a functional table for an example in which input pixel data is composed of 8 bits. The table shows prediction error groups which are classification information indicative of the magnitude range of prediction errors, overhead bit data for these prediction error groups, binary representations of the prediction errors, and the number of overhead bits. In contrast, Table 2 represents a functional table for an example in which input pixel data is composed of 10 bits. The table shows prediction error groups which are classification information indicative of the magnitude range of prediction errors of higher-order bits (8 bits), overhead bit data+lower-order bit data for these prediction error groups, binary representations of the prediction errors+the lower-order bit data, and the number of overhead bits+the number of lower-order bits. Table 3 shows variable-length codes obtained by variable-length encoding respective group information on prediction error groups indicative of the magnitude range of prediction errors, and an example (number of overhead bits+the number of lower-order bits, or the number of overhead bits before reduction) of the number of overhead bits+the number of lower-order bits (or noted along with an example of the number of overhead bits for an 8-bit input). Table 4 shows an example of the number of reduced bits (number of not-to-be-multiplexed bits excluded from the objects of encoding) on the lower-order bit side (or overhead bits) indicative of the specific value of a prediction error within a prediction error group. Here, the term lower-order bit side represents a concept inclusive of some of overhead bits indicative of the specific value of a prediction error within a prediction error group and the lower-order bits of an input pixel. Note that the list showing an example of the number of reduced bits on the lower-order bit side (or overhead bits) in Table 4 shows an example of the number of bits to be reduced for code quantity control applicable (usable) in the case of an example in which the input pixel data is composed of 10 bits. If the maximum number of reduced bits in prediction error group 5 is limited to 4, Table 4 can also be applied to an example in which input pixel data is composed of 8 bits. However, the extra lower-order 2 bits other than the 8 bits are always nullified in a case where the functional lists of Table 2 (example of 10-bit input) are used to cope with the number of valid input bits of 8. Thus, the number of bits obtained by adding 2 (number of invalid bits) to all of the code lists of Table 4 is specified as the number of not-to-be-encoded (multiplexed) bits.

The prediction error encoding unit 15 includes: a bit length detecting unit 151 configured to detect prediction error group information (see Table 1 or 2) indicative of a group to which the magnitude of the prediction error belongs, according to a prediction error input from the prediction error calculating unit 14, output the information to a later-described variable-length code table 152, and detect the number of overhead bits of the information (in the case of 8-bit input) or the number of overhead bits+the number of lower-order bits (in the case of 10-bit input)(see Table 1 or 2), wherein if the group is a prediction error group in which the magnitude of the prediction error is greater than a predetermined value (group number 5 or larger in Table 4), then the bit length detecting unit 151 detects overhead bits or the number of reduced bits on the lower-order bit side (concept inclusive of some of the overhead bits and the lower-order bits)(see Table 4) appropriate for the target code quantity difference level input from a later-described target code quantity difference level detecting unit 17 through a DFF 15-1, and outputs a total code length obtained by subtracting the number of bits to be reduced (value shown in Table 4) from the sum of a variable-length code length (see Table 3) received from the variable-length code table 152 and the number of overhead bits (expressed in 4 bits here) to a DFF 155 as a bit length; a variable-length encoding table 152 configured to output a variable-length code appropriate for the prediction error group information received from this bit length detecting unit 151 and the length of the variable-length code (see Table 3) to a later-described selector (MUX) 153, and outputs the length of the variable-length code to the bit length detecting unit 151; a selector (MUX) 153 configured to concatenate (multiplex) such a variable-length code received from the variable-length encoding table 152 as shown in Table 3 and such overhead bit data or overhead bits+lower-order bit data as shown in Table 1 or Table 2, in response to the prediction error group information received from the bit length detecting unit 151, and output the data as serial multiplexed data (referred to as encoded data); a DFF 155 configured to output the total code length data, which is the output of the bit length detecting unit 151, with a one-clock delay; and a DFF 154 configured to output the encoded data, which is the output of the selector 153, with a one-clock delay. Note that in the case of a prediction error group in which the magnitude of the prediction error is greater than a predetermined value (group number 5 or larger in Table 4), the bit length detecting unit 151 of the prediction error encoding unit 15 outputs a code length, which is shorter by the number of bits to be reduced shown in Table 4 (any one of integers from 1 to 5) than an original code length, as a total code length, according to the magnitude of the target code quantity difference level (target code quantity difference level 1 or higher in Table 4) output from the target code quantity difference level detecting unit 17. Accordingly, as many lower-order bits as the number of reduced bits of the overhead bits of the prediction error (in the case of 8-bit input) or overhead bits+lower-order bits (in the case of 10-bit input) are treated as invalid and excluded from the objects of encoding (multiplexing). Note that the total code lengths shown in Table 3 denote those before bit number reduction.

The packing unit 16 includes: an adder 163 configured to add the total code length (4-bits data here) input from the bit length detecting unit 151 through the DFF 155 and data (5-bit data here) obtained by accumulating this input total code length data and earlier total code length data retained in a DFF 164 each time one pixel is encoded (i.e., on a clock-by-clock basis), output the lower-order 5 bits of the addition result to the DFF 164 and, when the addition result attains a value of 32 bits (=4 bytes) or larger, output a one-bit signal indicative of this attainment to a DFF 165 as a 4-byte output signal; a selector (MUX) 161 configured to concatenate encoded data input through the DFF 154 (multiplexed data from the selector 153) following concatenated encoded data of less than 32 bits obtained by concatenating earlier encoded data output from the selector (MUX) 166, according to the addition result output from the DFF 164, thereby outputting the data thus concatenated as new concatenated encoded data; a DFF 162 configured to output the concatenated encoded data, which is the output of the MUX 161, with a one-clock delay; and a selector (MUX) 166 configured to output the higher-order 31 bits of the concatenated encoded data of the DFF 162 on the basis of the 4-byte output signal of the DFF 165, if the number of valid bits of the concatenated encoded data of the DFF 162 is 31 or smaller, or output concatenated encoded data composed of lower-order bits (the number of valid bits of these lower-order bits is 13 or smaller in the example of Table 3) except the higher-order 32 bits of the DFF 162 and invalid data (the value of the invalid data dose not matter and may be zero), if the number of valid bits of the concatenated encoded data of the DFF 162 is 32 or larger; wherein the selector (MUX) 166 outputs the concatenated encoded data in units of a predetermined code quantity (for example, in units of 4 bytes) along with an output signal having a predetermined unit (for example, a 4-byte output signal), and outputs output byte count information (for example, a 4-byte output signal) to the target code quantity difference level detecting unit 17.

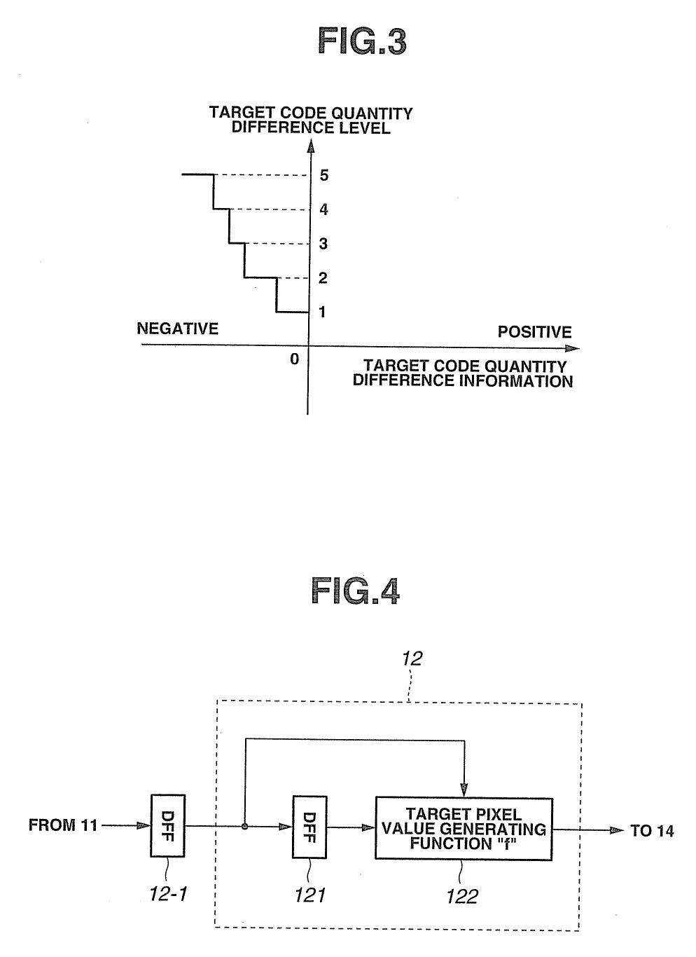

The target code quantity difference level detecting unit 17 includes: an adder 172 configured to add a set average code quantity (a code quantity of, for example, 7 bits per pixel) set by an unillustrated control unit and target code quantity difference information (result of code quantity difference accumulation) one clock earlier retained by a DFF 173, subtract the number of output bits (for example, 32) from the addition result if output byte count information (4-byte output signal) from the packing unit 16 is valid, and output the result of code quantity difference accumulation through the DFF 173 as target code quantity difference information; and a quantizing unit 174, to which the target code quantity difference information output from the DFF 173 is input, thereby performing quantization appropriate for the target code quantity difference information (see FIG. 3) and outputting the quantization result as a target code quantity difference level. That is, the target code quantity difference level detecting unit 17 calculates the target code quantity difference information as “(target code quantity obtained by accumulating the number of set average code quantities appropriate for the number of already-encoded pixels)−(output code quantity output for the number of already-encoded pixels)” and detects a target code quantity difference level indicative of a magnitude by which a generated code quantity (output code quantity) for the number of already-encoded pixels exceeds the target code quantity corresponding to the number of pixels.

Note that in the notation of the DFF 111 output (higher-order 8 bits of 10-bit data), for example, among notations in FIG. 2, 8-bit data composed of zeroth to seventh bits is represented as [7:0]. In addition, [7] represents a bit positioned in the highest-order place of 8-bit data.

FIG. 3 shows the input-output characteristics (quantization characteristics) of the quantizing unit 174 of the target code quantity difference level detecting unit 17. That is, FIG. 3 shows target code quantity difference levels output in response to target code quantity difference information which is an input to the quantizing unit 174. The horizontal axis represents the target code quantity difference information and the vertical axis represents the target code quantity difference level. Note that in the embodiments of the present invention, the magnitude of this target code quantity difference level is associated with “the number of bits to be corrected” (the number of bits to be reduced, meaning how many bits from the lowest-order bit upward should be reduced) (see Table 4). However, there is no need for any linear interrelation between the magnitude and the number. For example, although the number of bits to be corrected is specified as 3 for target code quantity difference level 3, the number may alternatively be 4. As shown in FIG. 3, the quantizing unit 174 has the characteristics in which if the target code quantity difference information is positive (i.e., the output code quantity of the packing unit does not exceed a target code quantity), then the target code quantity difference level is 0. If the target code quantity difference information is negative (i.e., the output code quantity of the packing unit exceeds the target code quantity), then the target code quantity difference level goes up to 1, 2, 3, 4 or 5, depending on the negative-side magnitude of the information.

In this way, even if the magnitude of the prediction error is greater than a predetermined value, lossless compression is performed in the positive-side domain of the target code quantity difference information. Lossy compression based on bit number reduction is performed only if the condition is satisfied that the magnitude of the prediction error is greater than the predetermined value and is in the negative-side domain of the target code quantity difference information.

TABLE 1
8-bit input

| | | | Binary | | |
|---|---|---|---|---|---|
| Prediction | | | representation of | Number of | Overhead bit |
| error group | Prediction error | | predicition error | overhead bits | data |
| 0 | −1 | 0 | SS SSSS SS | 1 | S |
| 1 | −2 | 1 | SS SSSS SN | 1 | S |
| 2 | −4 to −3 | 2 to 3 | SS SSSS Nf | 2 | Sf |
| 3 | −8 to −5 | 4 to 7 | SS SSSN ef | 3 | Sef |
| 4 | −16 to −9 | 8 to 15 | SS SSNd ef | 4 | Sdef |
| 5 | −32 to −17 | 16 to 31 | SS SNod ef | 5 | Scdef |
| 6 | −64 to −33 | 32 to 63 | SS Nbcd ef | 6 | Sbcdef |
| 7 | −128 to −65 | 64 to 127 | SN abcd ef | 7 | Sabcdef |

When the number of valid input bits is 8
“S” denotes positive/negative sign bit,
“N” denotes bit-inverted data, and
“SNabcdef” denotes data after difference calculation.

TABLE 2
10-bit input

| | | | | Number of | |
|---|---|---|---|---|---|
| | | | Binary representation | overhead bits + | Overhead bit |
| Prediction | | | of prediction error + | number of lower- | data + lower- |
| error group | Prediction error | | lower-order bit data | order bits | order bit data |
| 0 | −1 | 0 | SS SSSS SSgh | 3 | Sgh |
| 1 | −2 | 1 | SS SSSS SNgh | 3 | Sgh |
| 2 | −4 to −3 | 2 to 3 | SS SSSS Nfgh | 4 | Sfgh |
| 3 | −8 to −5 | 4 to 7 | SS SSSN efgh | 5 | Sefgh |
| 4 | −16 to −9 | 8 to 15 | SS SSNd efgh | 6 | Sdefgh |
| 5 | −32 to −17 | 16 to 31 | SS SNod efgh | 7 | Scdefgh |
| 6 | −64 to −33 | 32 to 63 | SS Nbcd efgh | 8 | Sbcdefgh |
| 7 | −128 to −65 | 64 to 127 | SN abcd efgh | 9 | Sabcdefgh |
| | | | ↑ | | |
| | | | x | | |

When the number of valid input bits is 10
“S” denotes a positive/negative sign bit,
“N” denotes bit-inverted data,
“SNabcdef” denotes data after difference calculation, and
“gh” denotes the lower-order bit data of input data before difference calculation.

TABLE 3

| | | | | Number of overhead | | |
|---|---|---|---|---|---|---|
| | | | Number of | bits + number of | Total code | |
| | | Length of | overhead bits | lower-order bits | length | |
| Prediction | Variable- | variable- | When in 8-bit | When in 10-bit | 8-bit | 10-bit |
| error group | length code | length code | input | input | input | input |
| 0 | 100 | 3 | 1 | 3 | 4 | 6 |
| 1 | 1110 | 4 | 1 | 3 | 5 | 7 |
| 2 | 101 | 3 | 2 | 4 | 5 | 7 |
| 3 | 00 | 2 | 3 | 5 | 5 | 7 |
| 4 | 01 | 2 | 4 | 6 | 6 | 8 |
| 5 | 110 | 3 | 5 | 7 | 8 | 10 |
| 6 | 11110 | 5 | 6 | 8 | 11 | 13 |
| 7 | 11111 | 5 | 7 | 9 | 12 | 14 |

TABLE 4

| Prediction | | | Target code quantity | | | | | |
|---|---|---|---|---|---|---|---|---|
| error group | Prediction error | | difference level | | | | | |
| 0 | −1 | 0 | 0 | 1 | 2 | 3 | 4 | 5 |
| 1 | −2 | 1 | 0 | 0 | 0 | 0 | 0 | 0 |
| 2 | −4 to −3 | 2 to 3 | 0 | 0 | 0 | 0 | 0 | 0 |
| 3 | −8 to −5 | 4 to 7 | 0 | 0 | 0 | 0 | 0 | 0 |
| 4 | −16 to −9 | 8 to 15 | 0 | 0 | 0 | 0 | 0 | 0 |
| 5 | −32 to −17 | 16 to 31 | 0 | 1 | 2 | 3 | 4 | 5 |
| 6 | −64 to −33 | 32 to 63 | 0 | 1 | 2 | 3 | 4 | 5 |
| 7 | −128 to −65 | 64 to 127 | 0 | 1 | 2 | 3 | 4 | 5 |

Pixels with small prediction errors (±15 or smaller) are always subject to lossless compression.

All pixels whose code quantities are smaller than a target code quantity are subject to lossless compression.

Next, the operation of the image compression apparatus of the first embodiment of the present invention will be described with reference to FIGS. 1 to 4 and Tables 1 to 4.

The target code quantity difference level detecting unit 17 shown in FIG. 1 detects a target code quantity difference level indicative of a magnitude by which a generative code quantity for the number of already-encoded pixels exceeds a target code quantity (=set average code quantity x the number of pixels) corresponding to the number of pixels. Specifically, like the target code quantity difference level detecting unit 17 shown in FIG. 2, the target code quantity difference level detecting unit 17 accumulates set average code quantities for each one clock and, each time encoded data having a predetermined number of bytes (for example, 4 bytes) is output from the packing unit 16, subtracts the output code quantity (number of output bytes) of the encoded data from the target code quantity (accumulation result) of the encoded data. Thus, the target code quantity difference level detecting unit 17 detects the magnitude of a level, at which the subtraction result is negative, as a target code quantity difference level. That is, the target code quantity difference level has a positive value appropriate for the negative magnitude of the subtraction result.

Note that since the number of bytes output from the packing unit 16 to the adder 172 shown in FIG. 2 is always 0 at the time of starting to input image data, the target code quantity difference information is positive. Consequently, the target code quantity difference level output from the quantizing unit 174 equals 0, according to the input-output characteristics (see FIG. 3) of the quantizing unit 174 shown in FIG. 2. Accordingly, at the time of starting to input image data, the pixel data input to the input pixel value correcting unit 11 is output to the predictive pixel value generating unit 12 and the prediction error calculating unit 14, without being corrected (irrespective of the error level sent from the error level detecting unit 13).

In the prediction error calculating unit 14 shown in FIG. 1, a prediction error is calculated by finding a difference between the current input pixel value (output of the DFF 12-1) and a predictive pixel value (output of the DFF 141) generated by referring to an earlier already-input pixel sent from the predictive pixel value generating unit 12.

If the number of valid input bits is 10, the prediction error encoding unit 15 shown in FIG. 1 detects such a prediction error group indicative of the magnitude of the prediction error as shown in Table 2, multiplexes the overhead bit data+lower-order bit data of the prediction error for such a prediction error group as shown in Table 2 with a variable-length code for such a prediction error group as shown in Table 3, and encodes the multiplexed data. Note that if the target code quantity difference level is 0 at this time, the number of reduced bits is 0 irrespective of the magnitude of the prediction error group (magnitude of the prediction error), as shown in Table 4, and, therefore, the lower-order bit side (some of the overhead bits and the lower-order bits) is not reduced.

The packing unit 16 shown in FIG. 1, which is specifically configured in the same way as the packing unit 16 shown in FIG. 2, sequentially cascades and retains input encoded data. Each time the bit length of the retained encoded data reaches 32 bits (i.e., 4 bytes) or beyond, the packing unit 16 outputs data of higher-order 4 bytes, among the retained encoded data, thereby excluding the output 4-byte data from the retained encoded data, and outputs the output byte count information (4-byte output signal) to the target code quantity difference level detecting unit 17. Accordingly, the output byte count information is output as zero to the target code quantity difference level detecting unit 17 until the retained encoded data reaches 4 bytes or beyond.

Now, an explanation will be made of a case in which encoding is continued in this way and the target code quantity difference level reaches 1 or beyond. The error level detecting unit 13 shown in FIG. 1 always detects the magnitude of a difference between the input pixel value and the predictive pixel value. If the magnitude is greater than a predetermined level (for example, not higher than −17 or not lower than 16, i.e., a level corresponding to one of prediction error groups Nos. 5 to 7, as shown in Table 4), the error level detecting unit 13 controls the input pixel value correcting unit 11, in order to correct the number of bits of lower-order bit data (the number of bits of 1 or larger in Table 4) of an input pixel value (higher-order bits) appropriate for the target code quantity difference level (number of corrected bits), so as to be the same as the lower-order bit data of the predictive pixel value. In this case, the lower-order bit data of a prediction error, which is calculated by the prediction error calculating unit 14 and has the number of bits appropriate for the target code quantity difference level, equals 0. Consequently, in the prediction error encoding unit 15, such overhead bit data+lower-order bit data (this lower-order bit data is the lower-order bits of input pixel data) as shown in Table 2 is concatenated to such the variable-length code of a prediction error group indicative of the magnitude of a prediction error as shown in Table 3. However, the prediction error encoding unit 15 excludes the number of bits on the lower-order side appropriate for the target code quantity difference level (0, 1, 2, 3, 4 or 5) from the overhead bit data+lower-order bit data, as shown in Table 4, before encoding the data.

Table 2 shows the relationship of the binary representation (two's complement representation) of a prediction error with prediction error group information and the number of overhead bits+the number of lower-order bits, and overhead bit data+lower-order bit data at the time of encoding. The column “binary representation of prediction error+lower-order bit data” shows 1 0-bit data in two's complement representation, where “S” denotes a positive/negative sign, “N” denotes bit data obtained by bit-inverting the positive/negative sign, and “abcdefgh” denotes bit data used in conjunction with the positive/negative sign “S” to identify a value within the group in question. “S” in the column “overhead bit data+lower-order bit data” denotes one bit of the positive/negative sign, and each “abcdefgh” denotes data in the corresponding bit position of the binary representation of a prediction error. Table 3 shows a list of variable-length codes corresponding to prediction error group information, as well as a list of the variable-length code lengths of the information, a list of the number of overhead bits+the number of lower-order bits (before bit number reduction based on a target code quantity difference level), and a list of total code lengths for the prediction errors in that case. Note that since input pixel data is composed of 10 bits, the column “number of overhead bits+number of lower-order bits” in Table 3 for 10-bit input is specified as numbers corresponding to the number of overhead bits+the number of lower-order bits in Table 2. At the time of encoding a prediction error, a variable-length code, overhead bits and lower-order bits appropriate for the prediction error group of the prediction error are serially concatenated and output as variable-length coded data.

Note that in Table 2 (as with Table 1), the bits (bits denoted by symbol X and arranged in tandem) second from the highest-order bit of the binary representation of the prediction error can be restored by referring to prediction error group information (0 to 7) and overhead bit data. It is therefore possible to omit [6] in the 8-bit overhead bit data [7:0] in the above-described concatenation processing (i.e., the data [7],[5:0] from which [6] has been deleted may be supplied as the 8-bit overhead bit data to be input to the selector 153 shown in FIG. 2).

The target code quantity difference levels 0, 1, 2, 3, 4 and 5 shown in Table 4 represent the steps of the magnitude of the above-described target code quantity difference levels, and correspond to the number of corrected bits (number of reduced lower-order bits) 0, 1, 2, 3, 4 and 5 specified as the target code quantity difference levels on the vertical axis of FIG. 3. Table 4 shows an example of the number of reduced bits of the overhead bit data+lower-order bit data of a prediction error. In the table, “number of overhead bits+number of lower-order bits” in prediction error groups 5 to 7 (i.e., the magnitude of the prediction error is not greater than −17 or not smaller than 16) is reduced by as much as ‘1’, ‘2’, ‘3’, ‘4’ or ‘5’, according to the target code quantity difference level (in other words, as many as the number of bits corresponding to 1 to 5 bits of the lower-order bit side of overhead bits+lower-order bits is excluded from the objects of encoding, if the prediction error group No. is 5 or larger and the target code quantity difference level is 1 or higher). Note that in the above-described example, 1 bit, 2 bits, 3 bits, 4 bits or 5 bits from the lowest-order bit of “overhead bit data+lower-order bit data” are deleted in each step 1, 2, 3, 4 or 5 of the magnitude of the target code quantity difference level, according to the steps. Alternatively, an increment in the number of reduced bits may be made nonlinear as in the example of reduction of 1 bit, 2 bits, 3 bits, 5 bits or 6 bits from the lowest-order bit of “overhead bit data+lower-order bit data”, according to each step 1, 2, 3, 4 or 5 of the magnitude of the target code quantity difference level. Still alternatively, the number of reduced bits may be varied depending on a difference in the prediction error group, even if the target code quantity difference level of the group is the same.

As described above, the prediction error encoding unit 15 excludes the corresponding number of reduced bits from the objects of encoding as shown in, for example, Table 4, according to the target code quantity difference level and the prediction error group (the corresponding number of reduced bits from the lowest-order bit upward is excluded before encoding is performed), before encoding the lower-order bit side of overhead bits+lower-order bits of a prediction error.

Note that decoding and reproduction on the decoding side will be explained in the second embodiment to be described next.

According to the first embodiment shown in FIGS. 1 and 2, cases where lossy compression applies (for example, the target code quantity difference information shown in FIG. 3 is on the negative side and the magnitude of a prediction error is greater than a predetermined value) are limited to a case where the magnitude of the prediction error is greater than the predetermined value i.e., a case where a pixel with a large brightness variation has occurred. Accordingly, it is possible to perform code quantity control without causing any visual image degradation.

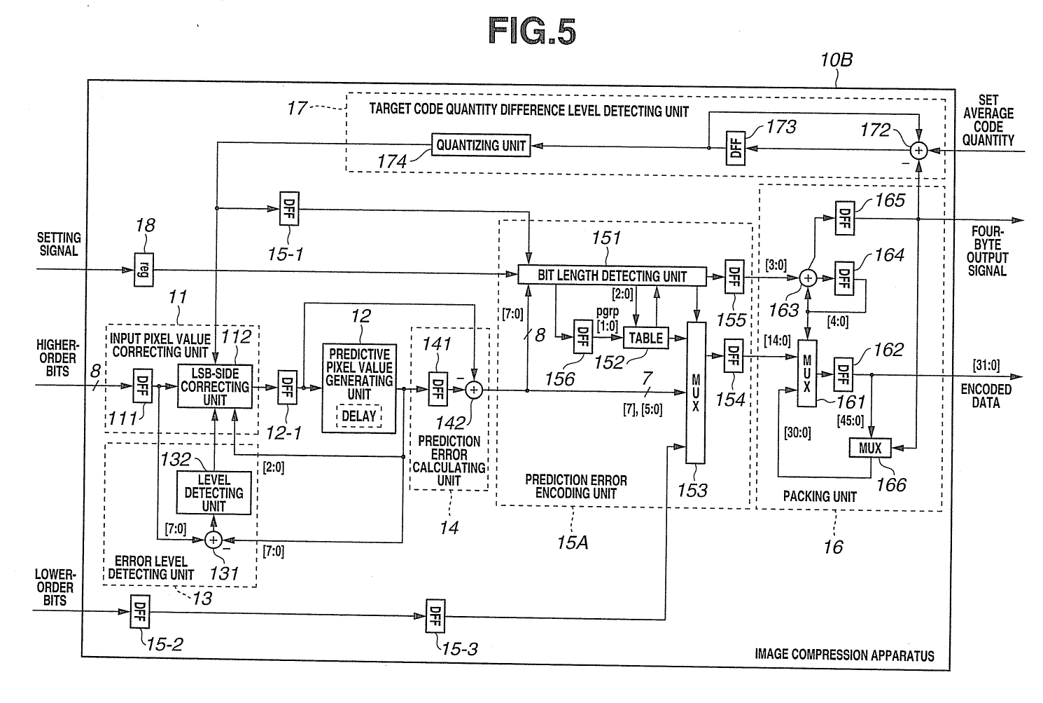

FIG. 5 is a block diagram showing another detailed configuration example of FIG. 1. Components having the same functions as those shown in FIGS. 1 and 2 are denoted by like reference numerals in the description to be made hereinafter.

Table 5 shows an example of a variable-length code table in which the variable-length code of a prediction error group is switched according to the range of a prediction error group one pixel earlier. Table 6 shows total code lengths resulting from code switching using the variable-length code table of Table 5 (before a bit reduction in the lower-order bit data of overhead bits or in the lower-side data of overhead bits+lower-order bits).

In contrast to the above-described configuration example of FIG. 2, an image compression apparatus 10B shown in FIG. 5 is configured so that a DFF 156 is provided in a prediction error encoding unit 15A as a storing unit used to store the classification (group) of the magnitude range of a prediction error one pixel earlier (see Table 5). Consequently, it is possible to further improve encoding efficiency by switching the variable-length code of the prediction error group indicative of a group to which the magnitude of the prediction error belongs, according to the range of a group of prediction errors one pixel earlier, as shown in Table 5. In Table 5, the magnitude range of a prediction error one pixel earlier is classified into four range groups, and 0 to 3 indicative of the prediction error group information ““pgrp”” one pixel earlier are represented using two bits (“pgrp” [1:0]) (see the DFF 156 output shown in FIG. 5). The range groups 0 to 3 indicative of the prediction error group information ““pgrp”” one pixel earlier are shown in Tables 5 and 6.

As the variable-length encoding table 152 in the configuration example of FIG. 5, the variable-length code table shown in Table 5 and the total code length table shown in Table 6 are used. In this example, the total code length before a bit reduction in the lower-order bit data of overhead bits or in the lower-side data of overhead bits+lower-order bits is specified as shown in Table 6, according to the prediction error group of a prediction error and prediction error group information ““pgrp”” one pixel earlier. Thus, the number of reduced bits shown in Table 4 is reduced from the total code length according to a target code quantity difference level (for example, in the case of 1 0-bit input, the lower-order bit side of overhead bit data+lower-order bit data of the prediction error is excluded from the objects of encoding).

TABLE 5

| | Prediction error one pixel earlier (pgrp) | | | |
|---|---|---|---|---|
| | | 1 | 2 | 3 |
| Prediction | 0 | −16 to −9 | −32 to −17 | −128 to −33 |
| error group | −8 to −7 | 8 to 15 | 16 to 31 | 32 to 127 |
| 0 | 100 | 100 | 1100 | 11110 |
| 1 | 101 | 1110 | 1101 | 11111 |
| 2 | 00 | 101 | 1110 | 1110 |
| 3 | 01 | 00 | 100 | 100 |
| 4 | 110 | 01 | 00 | 101 |
| 5 | 1110 | 110 | 01 | 00 |
| 6 | 11110 | 11110 | 101 | 01 |
| 7 | 11111 | 11111 | 11111 | 110 |

TABLE 6

| | Prediction error one pixel earlier (pgrp) | | | | | | | |
|---|---|---|---|---|---|---|---|---|
| | | | 1 | | 2 | | 3 | |
| | 0 | | −16 to −9, | | −32 to −17, | | −128 to −33, | |
| | −8 to −7 | | 8 to 15 | | 16 to 31 | | 32 to 127 | |
| Prediction | 8-bit | 10-bit | 8-bit | 10-bit | 8-bit | 10-bit | 8-bit | 10-bit |
| error group | input | input | input | input | input | input | input | input |
| 0 | 4 | 6 | 4 | 6 | 5 | 7 | 6 | 8 |
| 1 | 4 | 6 | 5 | 7 | 5 | 7 | 6 | 8 |
| 2 | 4 | 6 | 5 | 7 | 6 | 8 | 6 | 8 |
| 3 | 5 | 7 | 5 | 7 | 6 | 8 | 6 | 8 |
| 4 | 7 | 9 | 6 | 8 | 6 | 8 | 7 | 9 |
| 5 | 9 | 11 | 8 | 10 | 7 | 9 | 7 | 9 |
| 6 | 11 | 13 | 11 | 13 | 9 | 11 | 8 | 10 |
| 7 | 12 | 14 | 12 | 14 | 11 | 13 | 10 | 12 |

According to the configuration example of FIG. 5, the error level detecting unit 13 and the prediction error calculating unit 14 here correct lower-order bit data within input higher-order bits so as to be the same as the corresponding bit data of a corrected output pixel value one pixel earlier. Thus, the units detect an error level and a prediction error, while ignoring a code overflow to the higher-order side (referred to occasionally as degeneration). Accordingly, the dynamic range of difference data does not increase and a pixel value can be reproduced to the same value as the value of pixel value data output from the input pixel value correcting unit 11, thereby also improving compression efficiency.

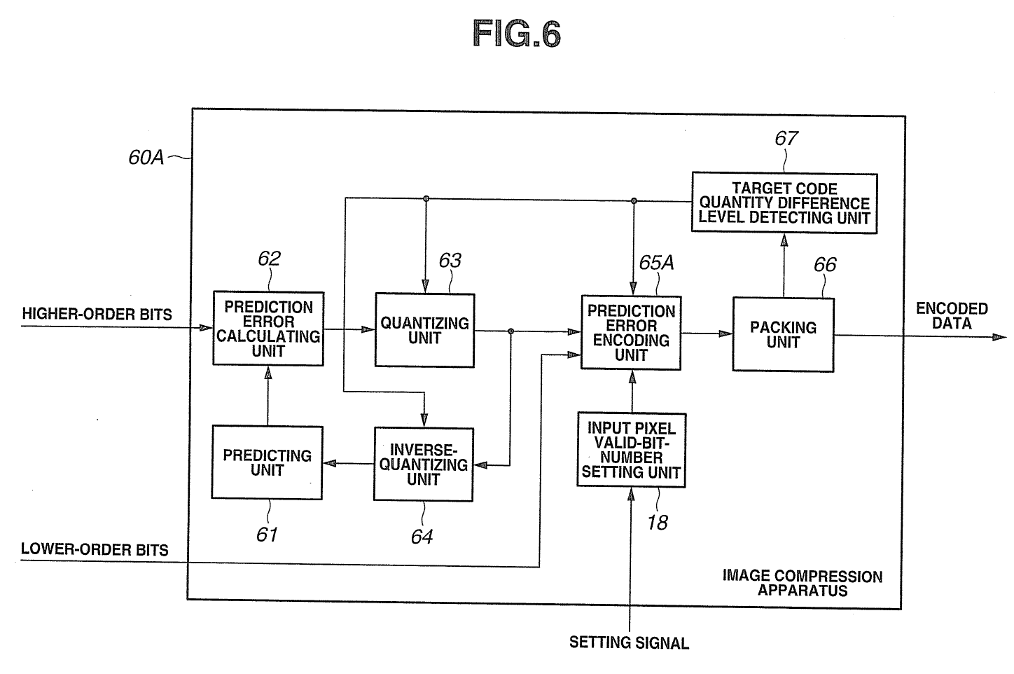

FIG. 6 is a block diagram showing an image compression apparatus having a block configuration different from the block configuration of FIG. 1. FIG. 6 shows an improved version of the configuration shown in FIG. 16 as a theoretical related art.

In response to a case where input pixel data is composed of 10 bits, the image compression apparatus is configured so that 8 bits, among the 10 bits, are input to the prediction error calculating unit 62 as higher-order bits subject to DPCM and the remaining 2 bits are directly input to a later-described prediction error encoding unit 65A as lower-order bits not subject to DPCM.

An image compression apparatus 60A shown in FIG. 6 includes: a predicting unit 61; a prediction error calculating unit 62; a quantizing unit 63; an inverse-quantizing quantizing unit 64; a prediction error encoding unit 65A; a packing unit 66; a target code quantity difference level detecting unit 67; and an input pixel valid-bit-number setting unit 18.

The prediction error calculating unit 62 calculates a difference (prediction error) between the higher-order bit value (8 bits) of input pixel data and a predictive pixel value (8 bits) created by the predicting unit 61, quantizes the difference by the quantizing unit 63, and sends the quantization result to the prediction error encoding unit 65A so as to be encoded therein.

Since the prediction error calculating unit 62 subtracts predictive data from current input data, the resulting difference data is 9-bit data having a ±sign bit. This 9-bit data is nonlinearly quantized by the quantizing unit 63 and is input to the prediction error encoding unit 65A. The target code quantity difference level detecting unit 67 compares an output code quantity, in which the encoded data provided by the prediction error encoding unit 65A is packed, with a target code quantity in units of a predetermined number of pixels. If the output code quantity is larger than the target code quantity, the quantizing unit 63 coarsens the width of nonlinear quantization before quantizing the data, and outputs the quantized data to the prediction error encoding unit 65A. If the output code quantity is smaller than the target code quantity, the quantizing unit 63 densifies the nonlinear quantization width before quantizing the data, and outputs the quantized data to the prediction error encoding unit 65A. Concurrently, the quantized data is also sent from the quantizing unit 63 to the inverse-quantizing unit 64. The inverse-quantizing unit 64 inverse-quantizes the quantized data to restore the data to gradation data before quantization, and supplies the data to the predicting unit 61. The predicting unit 61 retains (delays) the restored pre-quantization data for a one-pixel period to create a predictive data.

A prediction error on the higher-order bit side is quantized at the quantizing unit 63 according to a target code quantity difference level, and is input to the prediction error encoding unit 65A. The prediction error encoding unit 65A generates a variable-length code for the prediction error, concatenates (multiplexes) this variable-length code and the above-described lower-order bits not subject to DPCM, and outputs the multiplexed data to the packing unit 66. The packing unit 66 packs and outputs, in units of a predetermined number of bits, the quantization width information and the multiplexed encoded data provided in units of a plurality of pixels.

The prediction error encoding unit 65A determines the number of multiplexed bits (for example, 2 bits) of the above-described lower-order bits not subject to DPCM, according to the target code quantity difference level (i.e., according to the quantization width), if the number of valid bits of input pixel data is 10. If the number of valid bits of the input pixel data is 8, the prediction error encoding unit 65A does not at any time perform operation to multiplex the above-described lower-order bits not subject to DPCM. In order to control the number of multiplexed bits of the lower-order bits, the image compression apparatus is provided with an input pixel valid-bit-number setting unit 18 used to set whether the number of valid bits of the input pixel data is 10 or 8. The input pixel valid-bit-number setting unit 18 is provided with a register, in order to retain a signal having a predetermined number of bits indicative of the input pixel valid-bit-number (for example, one bit-signal indicative of whether the input pixel data is composed of 10 bits or 8 bits) for as long as a period of inputting a predetermined number of pixels (for example, a one-frame period) on the basis of a setting signal input from the outside, before outputting the signal to the prediction error encoding unit 65A. The rest of the configuration and operation is the same as those of FIG. 16. According to the first embodiment shown in FIGS. 1 to 6, it is possible to perform compression processing on various numbers of input bits, both on a small scale of configuration and at high speeds, using common encoding means. In addition, according to the embodiment shown in FIGS. 1 to 5, cases where lossy compression applies (for example, the target code quantity difference information shown in FIG. 3 is on the negative side and the magnitude of a prediction error is greater than a predetermined value) are limited to a case where the magnitude of the prediction error is greater than the predetermined value i.e., a case where a pixel with a large brightness variation has occurred. Accordingly, it is possible to perform code quantity control without causing any visual image degradation.

Furthermore, it is possible to further improve encoding efficiency by providing a storing unit configured to store group information on prediction error groups indicative of the magnitude range of a prediction error one pixel earlier and switching the variable-length code of group information showing a prediction error group indicative of the magnitude range of the prediction error according to the magnitude of the prediction error one pixel earlier.

### Second Embodiment

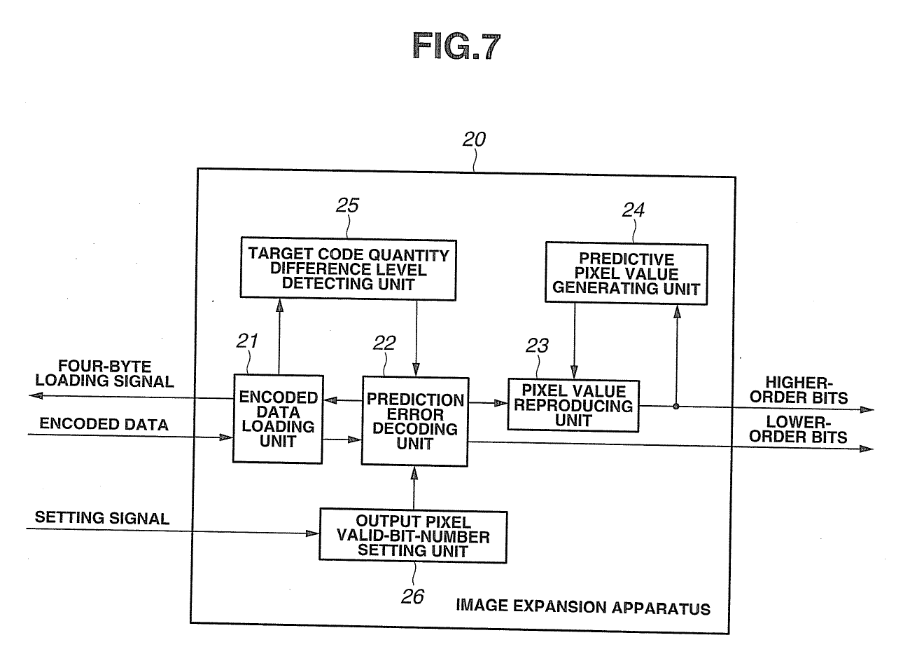

FIG. 7 is a block diagram showing an image expansion apparatus of a second embodiment of the present invention.

An image expansion apparatus 20 shown in FIG. 7 includes: an encoded data loading unit 21; a target code quantity difference level detecting unit 25; a prediction error decoding unit 22; a predictive pixel value generating unit 24; and an output pixel valid-bit-number setting unit 26.

The encoded data loading unit 21 loads encoded data sent from the image compression apparatus of the first embodiment. The target code quantity difference level detecting unit 25 detects a target code quantity difference level indicative of a magnitude by which a code quantity consumed for the number of already-decoded pixels exceeds a target code quantity corresponding to the number of pixels.

The prediction error decoding unit 22 decodes group information on a prediction error group indicative of the magnitude range of a prediction error of higher-order bits, overhead bits indicative of the specific value of the prediction error of the higher-order bits within the prediction error group, and lower-order bits appropriate for the output pixel valid-bit-number, out of variable-length code data output from the encoded data loading unit 21. Thus, the prediction error decoding unit 22 reproduces the prediction error of the higher-order bits and the lower-order bits appropriate for the output pixel valid-bit-number and detects the code length thereof.

The predictive pixel value generating unit 24 refers to an earlier already-reproduced pixel to generate a predictive pixel value. The pixel value reproducing unit 23 adds the reproduced prediction error to the predictive pixel value to reproduce the pixel value of the higher-order bits. The output pixel valid-bit-number setting unit 26 includes a register, in order to retain a one-bit signal indicative of the output pixel valid-bit-number (whether 10 bits or 8 bits) for as long as a period of decoding a predetermined number of pixels (for example, a one-frame period) on the basis of a setting signal input from the outside, before supplying the signal to the prediction error decoding unit 22.

The prediction error decoding unit 22 reproduces the lower-order bit side data (the lower-order side of overhead bits indicative of the prediction error value of the higher-order bits and lower-order bits determined according to the output pixel valid-bit-number) as 0, according to a target code quantity difference level, if the magnitude of the prediction error of the higher-order bits is greater than a predetermined value.

In the second embodiment having such a configuration as described above, lossy compression-based reproduction is performed in the image expansion apparatus configured to decode the prediction error encoded in the same way as in the first embodiment to reproduce lower-order bit side data (the lower-order side of the overhead bits of the reproduced prediction error of the higher-order bits and lower-order bits determined according to the output pixel valid-bit-number) as 0, according to the target code quantity difference level, if the prediction error of the higher-order bits is larger than a predetermined value. Thus, it is possible to realize an image expansion apparatus which does not either require transmitting pixel-by-pixel information on lossless and lossy compressions (for example, quantization width information) at the time of encoding for encoded data whose code quantity is controlled in units of pixels with lossless and lossy compressions combined.

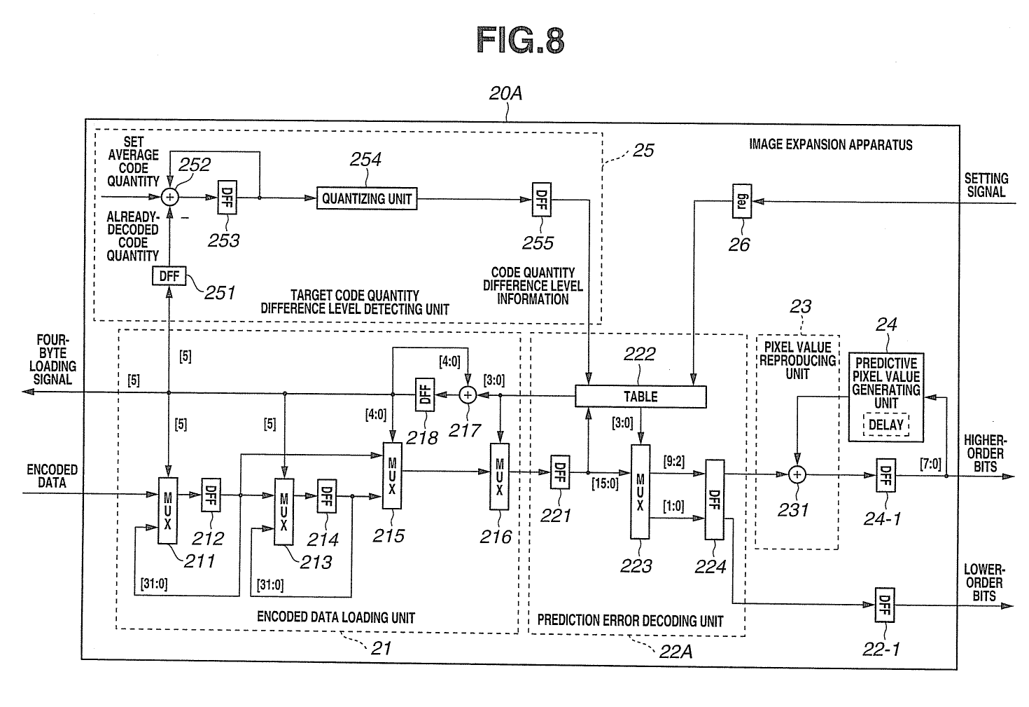

FIG. 8 is a block diagram showing one detailed configuration example of FIG. 7. Components having the same functions as those shown in FIG. 7 are denoted by like reference numerals in the description to be made hereinafter. An explanation will be made here of a case where input pixel data is composed of 10 bits.

An image expansion apparatus 20A shown in FIG. 8 is compatible with the image compression apparatus 10A shown in FIG. 2. In the image expansion apparatus 20A, an encoded data loading unit 21 receives encoded data (4-byte data) as an input, and loads the encoded data sequentially to a DFF 212 and a DFF 214 through a selector (MUX) 211 and a selector (MUX) 213 for each one clock during a period in which a 4-byte loading signal is valid. During a period in which the 4-byte loading signal is invalid, data already loaded to the DFF 212 and the DFF 214 is fed back through the MUX 211 and the MUX 213 and is retained. That is, this 4-byte loading signal is made valid for a period of two clocks by an unillustrated control circuit for initial data loading. Thereafter, the 4-byte loading signal is made valid for a period of one clock each time the number of decoded bits reaches 32 bits (4 bytes) or beyond. In this way, the encoded data retained in the DFF 212 and the DFF 214 is subjected to a cue search of variable-length codes at a stage one pixel earlier, as one serial data item, on the basis of information of less than 32 bits of the accumulation result of the number of bits of variable-length codes decoded by the selector (MUX) 215 until two pixels earlier.

The selector (MUX) 216 receives data output from this MUX 215 as an input, and makes a cue search of the variable-length code of the next pixel being decoded, on the basis of the number of bits (code length) of encoded data one pixel earlier sent from a variable-length code decoding table 222. An adder 217 adds code length data input from this variable-length code decoding table 222 and the lower-order 5 bits of the accumulation result one clock earlier retained in a DFF 218, and outputs 6-bit data including carry bits to the DFF 218. That is, the highest-order bit (sixth bit) data [5] output from the DFF 218 becomes valid and serves as the 4-byte loading signal each time the accumulation result of the number of bits of variable-length codes decoded until two pixels earlier reaches 32 bits (=4 bytes). This signal is delayed one clock by a DFF 251 and is supplied to the negative input end of the adder 252 of a target code quantity difference level detecting unit 25. In addition, data of lower-order 5 bits output from the DFF 218 is treated as information of less than 32 bits of the accumulation result of the number of bits of variable-length codes decoded until two pixels earlier, and is used as a cue of the variable-length codes to be searched by the MUX 215.

The prediction error decoding unit 22 includes:

a DFF 221 configured to cause a one-clock delay in variable-length encoded data output from the encoded data loading unit 21;

a variable-length code decoding table 222 (see Tables 3 and 4) configured to receive variable-length encoded data sent from the DFF 221 as an input, decode information on prediction error groups indicative of the magnitude range of the prediction error of higher-order bits and the code length thereof, reproduce the number of overhead bits used to indicate a specific value of the prediction error of higher-order bits within the group on the basis of the group information and lower-order bits appropriate for the output pixel valid-bit-number and, if the prediction error of the higher-order bits is larger than a predetermined value, reproduce the number of reduced bits (see Table 4) of the number of overhead bits according to the target code quantity difference level detected by the target code quantity difference level detecting unit 25 and lower-order bits appropriate for the output pixel valid-bit-number on the basis of the group information, thereby generating a total number of bits (code length) obtained by subtracting the number of reduced bits from a sum of the code length of the group information, the number of overhead bits and the number of lower-order bits;

a MUX 223 configured to remove the encoded data of the prediction error group information (group No.) from among data output from the DFF 221 on the basis of the code length of information (group No.) on a prediction error group obtained as a result of decoding using the variable-length code decoding table 222, extract and perform code expansion processing on the number of overhead bits+overhead bit data of the number of lower-order bits+lower-order bit data (see Table 2), and substitute the lower-order bit side data of the number of reduced bits, among the overhead bit data+lower-order bit data, with zero (see Table 4 for the conditions of substitution with 0 and the number of bits), thereby separating the data into the overhead bit data and the lower-order bit data before outputting the data; and

a DFF 224 configured to cause a one-clock delay respectively in the overhead bit data and in the lower-order bit data sent from the MUX 223. The conditions of substitution with 0 by the MUX 223 are that prediction error group No. is 5 or larger and the target code quantity difference level is 1 or higher if Table 4 is applied, where the magnitude of the target code quantity difference level is associated with ‘the number of corrected bits’ (the number of bits to be reduced, meaning how many bits from the lowest-order bit upward should be reduced). In Table 4, the maximum number of reduced bits equals 5 when the prediction error group No. is any of 5 to 7 and the target code quantity difference level is 5. Specifically, this maximum number of reduced bits of 5 corresponds to the lower-order bit side ‘defgh’ in the column “overhead bit data+lower-order bit data” shown in Table 2.

Note that a one-bit setting signal is supplied from a register composing the output pixel valid-bit-number setting unit 26 to table 222, according to the number of valid bits of output pixel data (whether 10 bits or 8 bits), so as to enable switching of the code table of table 222. In addition, if 10 bits are set as output pixel data, the higher-order 8 bits and the lower-order 2 bits are separately reproduced at the MUX 223. The timing relationship of the lower-order 2 bits with the higher-order 8 bits is adjusted by letting the 2 bits go through a DFF 22-1 in the post-stage of a DFF 224 before the 2 bits are output.

The target code quantity difference level detecting unit 25 includes: a DFF 251 to which information on the number of loaded bytes (4-byte loading signal) generated at the encoded data loading unit 21 is input by an unillustrated control unit at a point in time except a two-clock period for initial data loading, wherein the DFF 251 is configured to supply the information as an already-decoded code quantity in units of 4 bytes, to the negative input end of an adder 252 with a one-clock delay; an adder 252 configured to receive a set average code quantity (code quantity of, for example, 7 bits per pixel) set by an unillustrated control unit as one input, add this input set average code quantity to an accumulation result one clock earlier retained by a DFF 253, subtract a code quantity of 32 bits (4 bytes) from the accumulation result of set average code quantities each time a one-bit signal indicative of 4 bytes is input from the DFF 251, and output the result of the subtraction through the DFF 253 as target code quantity difference information; and a quantizing unit 254 configured to receive target code quantity difference information output from the DFF 253 as an input, perform the same predetermined quantization on the target code quantity difference information as is performed on the encoding apparatus side (see FIG. 3), and output the quantized information as a target code quantity difference level. That is, the target code quantity difference level detecting unit 25 successively subtracts the number of additionally loaded bytes from the accumulation result provided as a target code quantity (the number of bytes at the time of loading initial data is not subtracted, however, in order to apply the same initial conditions as those of the encoding side), and detects a level, at which the subtraction result is negative, as the target code quantity difference level.

The pixel value reproducing unit 23 includes an adder 231 configured to add a prediction error reproduced by the prediction error decoding unit 22 to a predictive pixel value sent from the predictive pixel value generating unit 24, thereby reproducing a pixel value.

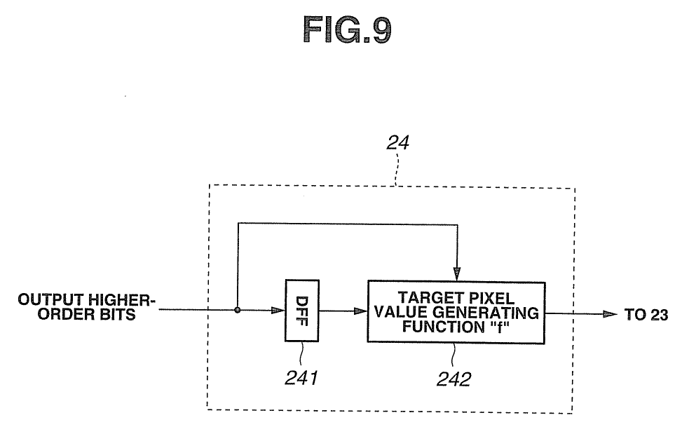

The predictive pixel value generating unit 24 refers to an earlier already-reproduced pixel input by causing a one-clock delay in a pixel value reproduced by the pixel value reproducing unit 23 using a DFF 24-1, thereby generating a predictive pixel value. The predictive pixel value generating unit 24 may, for example, refer only to the output of the pre-stage DFF 24-1 used to cause a one-clock delay, and let the output pass through as is (that is, the predictive pixel value generating unit 24 may configured with a signal line alone to apply the one-clock-delayed signal sent from the DFF 24-1 as the predictive pixel value). Alternatively, the predictive pixel value generating unit 24 may use the one-clock-delayed signal provided by the DFF 24-1 and a signal delayed one clock further by letting the one-clock-delayed signal go through another flip-flop DFF 241 (that is, a two-clock-delayed signal provided by the two flip-flops DFF 24-1 and DFF 241), as shown in FIG. 9, to perform calculations at a calculating unit 242 using a predetermined predictive pixel value generating function formula “f”, thereby generating the predictive pixel value. Note that this number of pixels to be referred to may be even larger, provided that the number of pixels to be referred to and the function formula “f” are the same as those of the encoding apparatus side.

Next, the operation of the image expansion apparatus of the second embodiment of the present invention will be described with reference to FIGS. 7 to 9.

The encoded data loading unit 21 loads encoded data from the image compression apparatus in units of a predetermined number of bytes according to the code length of an already-decoded pixel sent from the prediction error decoding unit 22, and supplies data, in which a cue search of the next image data has been made, to the prediction error decoding unit 22. Here, the target code quantity difference level detecting unit 25, as is specifically shown in the target code quantity difference level detecting unit 25 of FIG. 8, accumulates set average code quantities for each one clock each time additional data of a predetermined number of bytes is loaded by the encoded data loading unit 21, subtracts the number of additionally loaded bytes provided as the output code quantity of the unit from the accumulation result, which is the target code quantity of the unit (note that the number of bytes at the time of loading initial data is not subtracted), and detects a level, at which the subtraction result is negative, as the target code quantity difference level.

The prediction error decoding unit 22 reproduces group information (group No.) showing a prediction error group indicative of the magnitude range of a prediction error, out of variable-length code data output from the encoded data loading unit 21 on the basis of Table 3 provided as variable-length code decoding table 222, and reproduces an original prediction error out of overhead bit data indicative of the specific value of a prediction error within each group on the basis of Table 2. At that time, if the level of group information is higher than a predetermined level (for example, not higher than −17 or not lower than 16, i.e., corresponding to group Nos. 5 to 7), table 222 substitutes the lower-order bit side of overhead bit data+lower-order bit data of a reproduced prediction error with 0 on the basis of the number of reduced bits shown in Table 4 before outputting the data, according to a target code quantity difference level detected by the target code quantity difference level detecting unit 25. Consequently, reproduction is possible without the need to transmit pixel-by-pixel information on lossless and lossy compressions (for example, quantization width information) at the time of encoding.

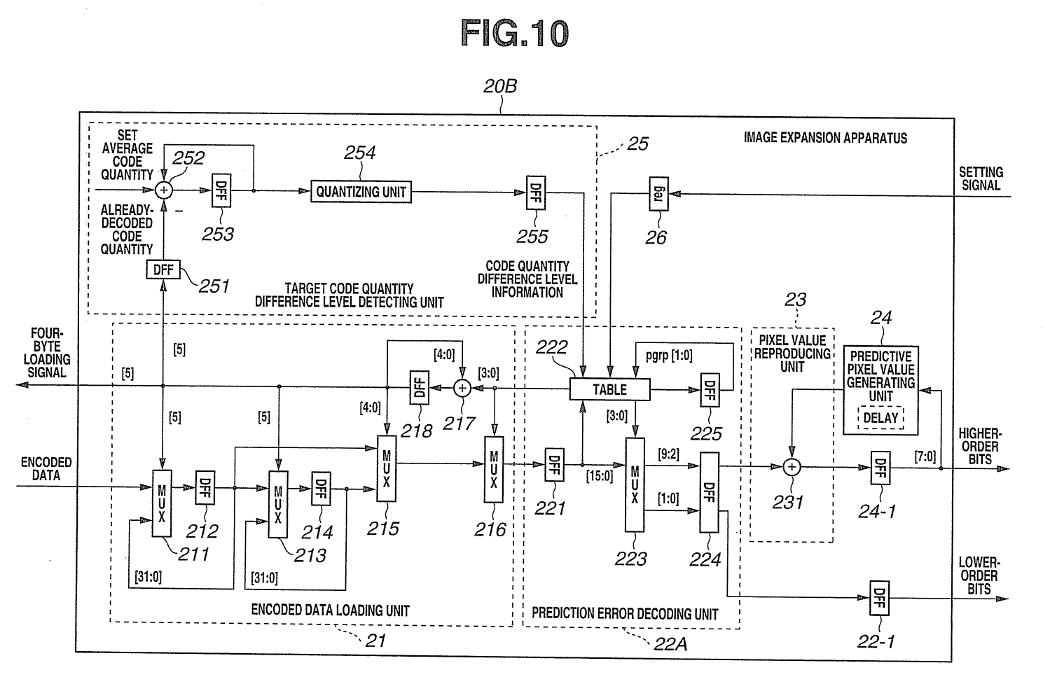

FIG. 10 is a block diagram showing another detailed configuration example of FIG. 7. Components having the same functions as those of FIGS. 7 and 8 are denoted by like reference numerals in the description to be made hereinafter.

An image expansion apparatus 20B shown in FIG. 10 is compatible with the image compression apparatus 10B shown in FIG. 5. In contrast to the above-described configuration example of FIG. 8, a DFF 225 is provided as a storing unit configured to store the group information “pgrp” of a prediction error group indicative of the magnitude range of a prediction error one pixel earlier, as shown in the prediction error decoding unit 22A of FIG. 10. Thus, it is possible to decode the prediction error without the need for information on code table switching from the encoding side, by switching the variable-length code of group information (group No.) of a prediction error group indicative of the magnitude range of a prediction error, as shown in Table 5, depending on the prediction error group information “pgrp” one pixel earlier. As the variable-length code decoding table 222 shown in FIG. 10, Tables 2 and 4 to 6 are used.

Note that Tables 2, 3 and 5 shown in the first embodiment are also used in the second embodiment. However, the correlation between the prediction error group information and the variable-length code (Tables 3 and 5) and the correlation between the binary representation+lower-order bit data of the prediction error and the overhead bit data+lower-order bit data (Table 2) are reversed between compression processing in the first embodiment and expansion processing in the second embodiment, when using these tables.

According to such a configuration of the second embodiment as described above, it is possible to perform expansion processing on various numbers of input bits, both on a small scale of configuration and at high speeds, using common decoding means in an image expansion apparatus configured to decode a prediction error encoded as described in the first embodiment.

According to the configuration shown in FIGS. 7 to 10, overhead bits indicative of the specific value of the prediction error of higher-order bits within each group and lower-order bits appropriate for the output pixel valid-bit-number are decoded on the basis of a target code quantity difference level calculable at the time of decoding and the group information of a prediction error group indicative of the magnitude range of the prediction error of encoded higher-order bits, and the prediction error of the higher-order bits is reproduced on the basis of the decoded overhead bits. Accordingly, there is no need for pixel-by-pixel information on lossless and lossy compressions (for example, quantization width information) at the time of encoding.

By performing lossy compression-based reproduction to reproduce the lower-order bit side data of overhead bits of the reproduced prediction error of higher-order bits and the lower-order bits appropriate for the output pixel valid-bit-number as 0, according to the target code quantity difference level, if the prediction error of the higher-order bits is larger than a predetermined value, it is possible to realize an image expansion apparatus which does not require transmitting pixel-by-pixel information on lossless and lossy compressions at the time of encoding (for example, quantization width information) for encoded data subjected to code quantity control on a pixel-by-pixel basis with lossless and lossy compressions combined.

In addition, by providing a storing unit used to store a prediction error one pixel earlier and switching the variable-length code of group information of a prediction error group indicative of the magnitude range of the prediction error of higher-order bits according to the prediction error of higher-order bits one pixel earlier, it is possible to perform decoding without the need for code table switching from the encoding side.

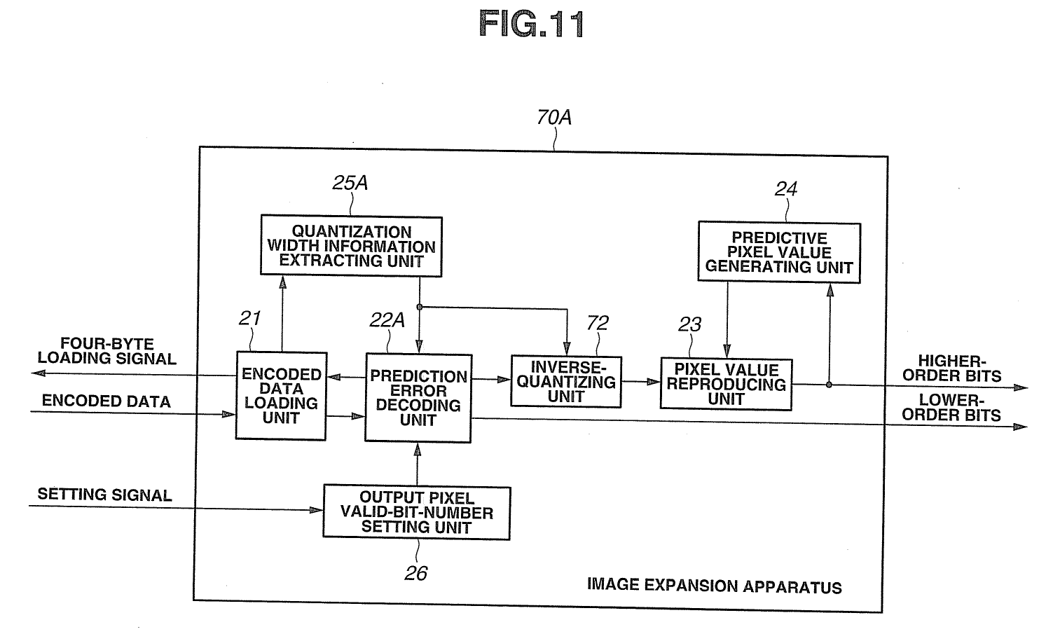

FIG. 11 is a block diagram showing a configuration example of an image expansion apparatus 70A compatible with the image compression apparatus 60A of FIG. 6. FIG. 11 corresponds to the image expansion apparatus 70 of FIG. 17 shown as a theoretical related art. In FIG. 11, components having the same functions as those shown in FIG. 17 are denoted by like reference numerals in the description to be made hereinafter.

The image expansion apparatus 70A shown in FIG. 11 includes: an encoded data loading unit 21; a quantization width information extracting unit 25A; a prediction error decoding unit 22B; an inverse-quantizing unit 72; a predictive pixel value generating unit 24; a pixel value reproducing unit 23; and an output pixel valid-bit-number setting unit 26.

The encoded data loading unit 21 loads encoded data sent from the image compression apparatus 60A of FIG. 6. The quantization width information extracting unit 25A extracts quantization width information used for the unit of a plurality of pixels from the encoded data.

The prediction error decoding unit 22A decodes lower-order bits appropriate for an output pixel valid-bit-number out of variable-length code data output from the encoded data loading unit 21, thereby reproducing the prediction error of higher-order bits and lower-order bits appropriate for the output pixel valid-bit-number and detecting a code length.

The inverse-quantizing unit 72 inverse-quantizes the reproduced prediction error of the higher-order bits according to the extracted quantization width information. The predictive pixel value generating unit 24 refers to an earlier already-reproduced pixel to generate a predictive pixel value. The pixel value reproducing unit 23 adds the inverse-quantized (reproduced) prediction error of the higher-order bits to the predictive pixel value to reproduce the pixel value of the higher-order bits.

The output pixel valid-bit-number setting unit 26 includes a register, in order to retain a one-bit signal indicative of an output pixel valid-bit-number (whether 10 bits or 8 bits) for as long as a period of decoding a predetermined number of pixels (for example, a one-frame period) on the basis of a setting signal input from the outside, before supplying the signal to the prediction error decoding unit 22A.

The prediction error decoding unit 22A reproduces the lower-order bits appropriate for the output pixel valid-bit-number as 0, if the magnitude of the quantization width information is greater than a predetermined value.

According to the configuration of FIG. 11, it is possible to perform expansion processing on various numbers of input bits, both on a small scale of configuration and at high speeds, using common decoding means.

### Third Embodiment

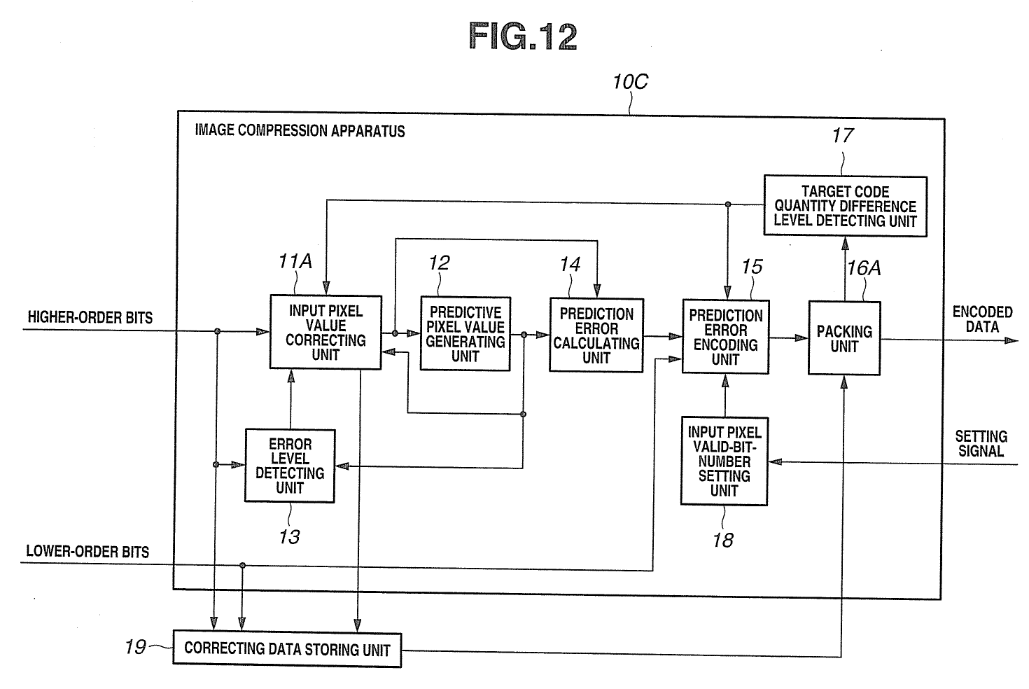

FIG. 12 is a block diagram showing an image compression apparatus of a third embodiment of the present invention. Components having the same functions as those shown in the configuration of FIG. 1 in the first embodiment are denoted by like reference numerals in the description to be made hereinafter.

An image compression apparatus 10C shown in FIG. 12 includes: an input pixel value correcting unit 11A; a predictive pixel value generating unit 12; an error level detecting unit 13; a prediction error calculating unit 14; a prediction error encoding unit 15; a packing unit 16A; a target code quantity difference level detecting unit 17; a correcting data storing unit 19; and an input pixel valid-bit-number setting unit 18.

The input pixel value correcting unit 11A has the function to replace (correct) lower-order bit data within the higher-order bits of input pixel data, according to an error level between an input pixel value and a predictive pixel value and a target code quantity difference level, so that the lower-order bit data is the same as the corresponding bit data (lower-order bit data) of a corrected output pixel value (predictive pixel value) one pixel earlier. In addition to this function, the input pixel value correcting unit 11A has the function to output the number of replaced bits and a pixel position, where the data has been replaced, to the correcting data storing unit 19 when the replacement is performed.

The predictive pixel value generating unit 12 refers to the higher-order bits of an earlier already-input pixel to generate a predictive pixel value for the higher-order bits of a new input pixel.

The error level detecting unit 13 detects an error level indicative of the magnitude of a difference between the higher-order bit values of the predictive pixel value and the input pixel value.

The prediction error calculating unit 14 calculates a prediction error which is a difference between a pixel value output from the input pixel value correcting unit 11 and the predictive pixel value.

The target code quantity difference level detecting unit 17 detects a target code quantity difference level indicative of a magnitude by which a generated code quantity for the number of already-encoded pixels exceeds a target code quantity for the number of pixels.

The correcting data storing unit 19 is connected to the higher-order bit line and the lower-order bit line of input pixel data, and sequentially stores as many pre-replacement data items (lower-order bit data within the higher-order bits of input pixel data) as the number of bits of the lower-order bit data, according to information from the input pixel value correcting unit 11A, when the lower-order bit data within the higher-order bits are replaced. When the lower-order bit data is not replaced, the correcting data storing unit 19 does not store anything. For the lower-order bits, the correcting data storing unit 19 stores lower-order bit data not included in the objects of encoding (i.e., included in the objects of reduction).

The prediction error encoding unit 15 is configured to multiplex (encode) the variable-length coded prediction error group information indicative of the magnitude range of the prediction error calculated by the prediction error calculating unit 14, overhead bits indicative of the specific value of a prediction error within the prediction error group, and lower-order input pixel bits appropriate for an input pixel valid-bit-number. In a case where the prediction error group is greater than a predetermined value, the prediction error encoding unit 15 excludes some of the lower-order bits (overhead bits of the prediction error and lower-order input pixel bits) from the objects of encoding (multiplexing) before encoding the prediction error, according to the target code quantity difference level. This function is the same as explained in FIG. 1.

The packing unit 16A has the function to pack and output encoded data sent from the prediction error encoding unit 15, in units of a predetermined code quantity (in units of a predetermined number of bits). In addition to this function, the packing unit 16A has the function to additionally pack and output lower-order bit data within the replaced higher-order bits sent from the correcting data storing unit 19 and data on lower-order bits not included in the objects of encoding, up to the amount of code quantity left over as a result of the capacity of a memory unit having the unit of fixed length setting (for example, setting in units of lines) being not filled up, after the completion of this packing. This function of additional packing and outputting may not be provided in the packing unit 16A but may be provided independently of this unit.

Note that the image compression apparatus of FIG. 12 is configured so that whether the input pixel is composed of 10 bits or 8 bits is set for the prediction error encoding unit 15 in the same way as shown in FIG. 1, using the input pixel valid-bit-number setting unit 18. However, the main subject matter of the present embodiment lies in the correcting data storing unit 19 configured to temporarily store data, so as to store pre-replacement bits and reduced bits (hereinafter occasionally referred to as correcting data) in the left-over area of the memory unit having the unit of fixed length setting (for example, setting in units of lines), and in the packing unit 16A configured to additionally pack and output those temporarily stored pre-replacement bits and reduced bits after the completion of packing the output data of the prediction error encoding unit 15. Accordingly, the subject matter of the present embodiment can also be applied to an image compression apparatus that doses not include the input pixel valid-bit-number setting unit 18.

In the above-described configuration, the memory unit having the unit of line-by-line setting as the unit of fixed length setting is provided for a plurality of lines in response to the type of screen image, so as to be able to control line-by-line code quantities. In a case where data, the code length of which is long due to a signal having a large variation on the left side of a screen image, is used for a certain continuous period but the signal has an extremely small variation and is flat on the right side of the screen image, there arises the problem that storage areas are left over since the signal is flat on the right side of the screen image, whereas lossy compression is applied on the left side of the screen image. Hence, after the completion of encoding one line, pre-replacement bits and reduced bits (i.e., bits responsible for lossy compression) that have been discarded conventionally are additionally output in sequence to a storage area left over within a memory area allocated to that one line.

Consequently, in a receiving-side (reproduction-side) image expansion apparatus, it is possible to decode and reproduce pixel data encoded and compressed by an image compression apparatus and correct and restore the reproduced data using pre-replacement bit data and reduced bit data. Thus, it is possible to effectively use the pre-replacement bits and reduced bits of lossy-compressed parts of pixel data that have been discarded conventionally on the encoding side.

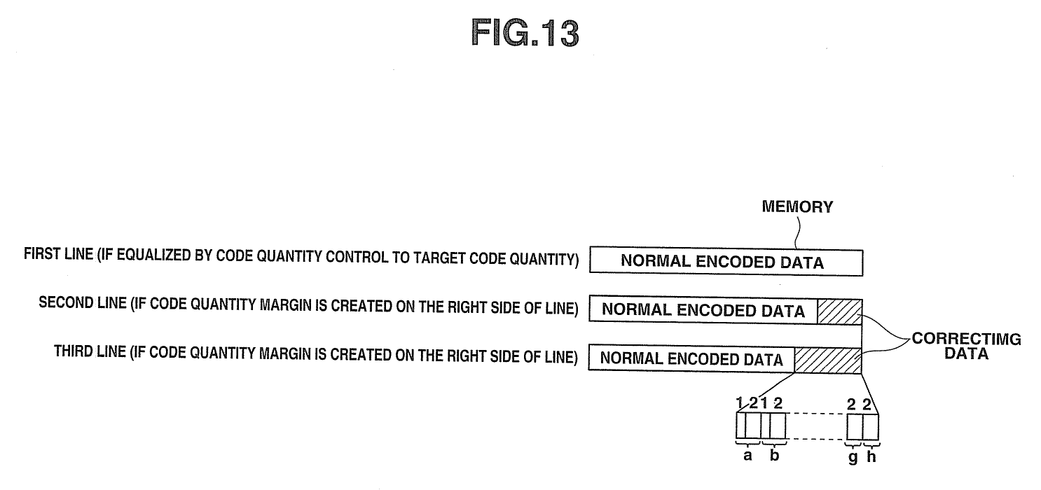

FIG. 13 shows a memory unit for storage in units of one line, wherein regular encoded data having a certain code quantity is stored in a first-line memory area, and there is no storage area left over in the memory area since the code quantity agrees with a target code quantity. Thus, any correcting data corresponding to the encoded data is not stored in the memory area. In second-line and third-line memory areas, however, there are left-over storage areas shown as shaded areas, since a generated code quantity in the second half of the line falls short of the target code quantity. Thus, pre-replacement bits and reduced bits generated, for example, in the first half of the line are additionally stored in these left-over storage areas as correcting data. Correcting data to be additionally stored in the second-line or third-line memory area is additionally stored in such a sequence as one bit of the lower-order bit data of higher-order bits, then lower-order two bits following the one bit (shown by code “a”) and, likewise, one bit of the lower-order bit data of higher-order bits, then lower-order two bits following the one bit (shown by code “b”), . . . , and lower-order two bits (shown by code “g”), then lower-order two bits (shown by code “h”).

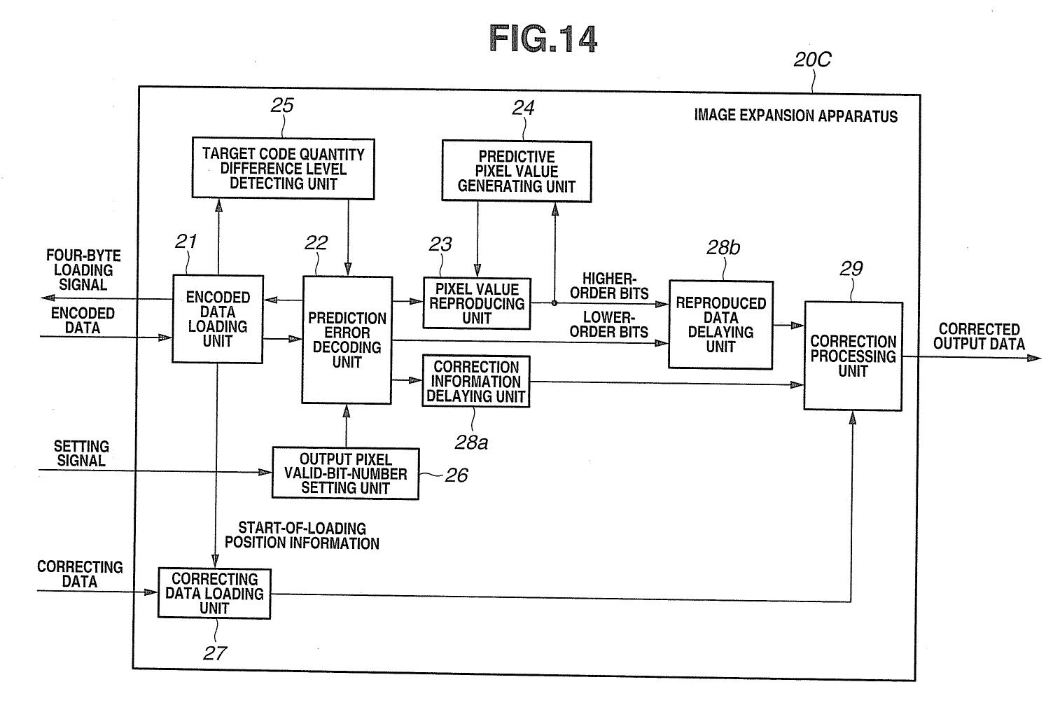

FIG. 14 is a block diagram showing an image expansion apparatus compatible with the image compression apparatus of FIG. 12. Components having the same functions as those shown in the configuration of FIG. 7 in the first embodiment are denoted by like reference numerals in the description to be made hereinafter.

An image expansion apparatus 20C shown in FIG. 14 includes: an encoded data loading unit 21; a prediction error decoding unit 22; a pixel value reproducing unit 23; a predictive pixel value generating unit 24; a target code quantity difference level detecting unit 25; an output pixel valid-bit-number setting unit 26; a correcting data loading unit 27; a correction information delaying unit 28a; a reproduced data delaying unit 28b; and a correction processing unit 29.

The encoded data loading unit 21 is provided in order to load encoded data sent from the image compression apparatus 10C shown in FIG. 12. If such line-by-line encoded data as shown in FIG. 13 is successively sent from each memory area, the entirety of first-line data is loaded to the encoded data loading unit 21. For the second-line and third-line data, however, only the encoded data parts (unshaded parts) thereof are loaded to the encoded data loading unit 21. The encoded data loading unit 21 is configured so that start-of-loading position information on subsequent correcting data (address information on the end of the encoded data for allocated memory capacity having the unit of fixed length setting, for example, setting in units of one line) is supplied from the encoded data loading unit 21 to the correcting data loading unit 27 at the timing of the end of encoded data loading.

The correcting data loading unit 27 is configured so that the correcting data is loaded, starting from a precise data position, on the basis of the start-of-loading position information from the encoded data loading unit 21.

Here, as far as the timings of data loading and correcting data loading are concerned, an unillustrated pre-stage separating unit may be provided, so that subsequent second-line correcting data starts to be loaded to the correcting data loading unit 27 after the second-line encoded data is loaded to the encoded data loading unit 21, and the third-line encoded data starts to be loaded to the encoded data loading unit 21 at the same timing as the timing at which the correcting data starts to be loaded. That is, control can be performed so that two types of data are simultaneously started to be loaded to the encoded data loading unit 21 and the correcting data loading unit 27, respectively.

The target code quantity difference level detecting unit 25 detects a target code quantity difference level indicative of a magnitude by which a code quantity consumed for the number of already-decoded pixels exceeds a target code quantity corresponding to the number of pixels.

The prediction error decoding unit 22 has the function to decode group information on a prediction error group indicative of the magnitude range of the prediction error of higher-order bits, overhead bits indicative of a specific value of the prediction error of the higher-order bits within the prediction error group, and lower-order bits appropriate for an output pixel valid-bit-number, out of variable-length code data output from the encoded data loading unit 21, thereby reproducing the prediction error of the higher-order bits and the lower-order bits appropriate for the output pixel valid-bit-number and detecting a code length. In a case where the magnitude of the prediction error of the higher-order bits is greater than a predetermined value, the prediction error decoding unit 22 performs lossy compression-based reproduction to reproduce the lower-order bit side data of the overhead bits indicative of the value of the prediction error of the higher-order bits and the lower-order bits appropriate for the output pixel valid-bit-number as 0, according to a target code quantity difference level.

The predictive pixel value generating unit 24 refers to an earlier already-reproduced pixel to generate a predictive pixel value. The pixel value reproducing unit 23 adds a reproduced prediction error to the predictive pixel value to reproduce the pixel value of higher-order bits.

The output pixel valid-bit-number setting unit 26 includes a register, in order to retain a one-bit signal indicative of the output pixel valid-bit-number (whether 10 bits or 8 bits) for as long as a period of decoding a predetermined number of pixels (for example, a one-frame period) on the basis of a setting signal input from the outside, before supplying the signal to the prediction error decoding unit 22.

The correction information delaying unit 28a retains information as to how large the number of corrected bits is, and corrected pixel position information (which may alternatively be a storage address).

The reproduced data delaying unit 28b, to which lower-order bits sent from the prediction error decoding unit 22 and higher-order bits sent from the pixel value reproducing unit 23 are input, is configured to adjust the timing relationship between correcting data from the correcting data loading unit 27 and correction information from the correction information delaying unit 28a.

The correction processing unit 29 replaces the above-described replaced bit data and reduced bit data (i.e., correcting data) in reproduced data from the reproduced data delaying unit 28b with pre-replacement bit data and reduced bit data, using the correction information from the correction information delaying unit 28a, thereby outputting the reproduced data as corrected and restored output data.

Note that the image expansion apparatus of FIG. 14 is configured so that whether the output pixel is composed of 10 bits or 8 bits is set for the prediction error decoding unit 22 in the same way as shown in FIG. 7, using the output pixel valid-bit-number setting unit 26. However, the main subject matter of the present embodiment is that pre-replacement bits and reduced bits are stored in a left-over area of a memory unit having the unit of fixed length setting (for example, setting in units of lines), and the pre-replacement bit data and the reduced bit data are subjected to fixed length setting in combination with encoded data and sent to the receiving-side image expansion apparatus. In the image expansion apparatus, the above-described pre-replacement bit data and reduced bit data at the time of encoding are corrected and restored using the pre-replacement bit data and the reduced bit data, and then output. Accordingly, the subject matter of the present embodiment can also be applied to an image expansion apparatus that doses not include the output pixel valid-bit-number setting unit 26.

According to the third embodiment, it is possible to effectively use a memory unit, as well as pre-replacement bits and reduced bits that have been discarded conventionally. In addition, the third embodiment has the great advantage that on the decoding side, it is possible to reversibly decode encoded data, including data parts irreversibly compressed on the encoding side.

### Fourth Embodiment

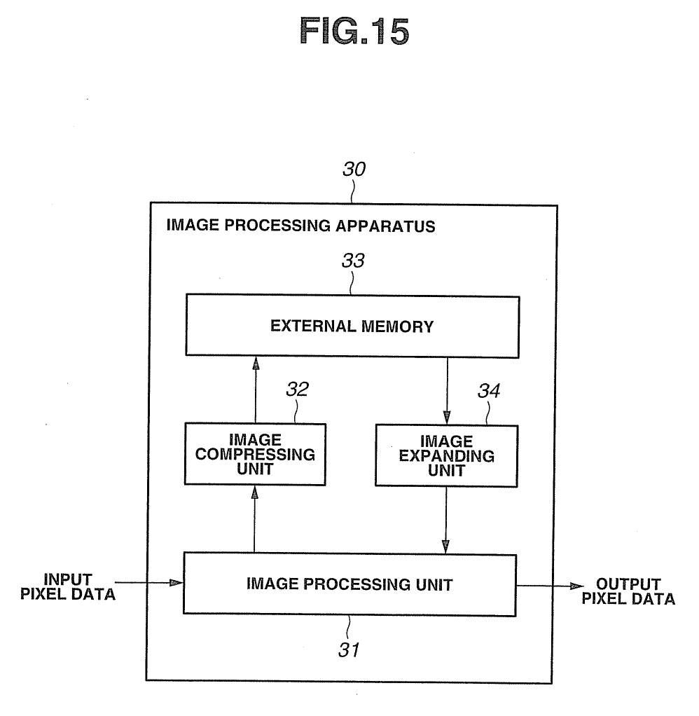

FIG. 15 is a block diagram showing an image processing apparatus of a fourth embodiment of the present invention.

An image processing apparatus 30 shown in FIG. 15 includes: an image compressing unit 32 provided with the image compression apparatus shown in FIG. 1, 2 or 5; an image expanding unit 34 provided with the image expansion apparatus shown in FIG. 7, 8 or 10; an external memory unit 33; and an image processing unit 31. The image processing unit 31 temporarily stores the result of intermediate processing obtained by processing input image data in the external memory unit 33 through the image compressing unit 32, reads a plurality of intermediate processing results stored in the external memory unit 33 through the image expanding unit 34, and outputs an image-processed final processing result.

According to the fourth embodiment, cases where lossy compression is applied are limited to a case where the magnitude of a prediction error is greater than a predetermined value, i.e., a pixel with a large brightness variation has occurred, and the target code quantity difference level is 1 or higher (for example, a case where a comparatively large brightness variation takes place in succession in the vicinity of the pixel, thus causing the target code quantity difference information shown in FIG. 3 to take a negative-side value). Accordingly, the loss of a pixel value in such an area does not adversely affect visual image quality. Thus, it is possible to obtain a highly-sophisticated image processing result by controlling the capacity of the external memory unit and a memory bandwidth.

Note that the image processing apparatus may also have a configuration in which the image compression apparatus shown in FIG. 12 is used as the image compressing unit 32 in the image processing apparatus of FIG. 15, and the image expansion apparatus shown in FIG. 14 is used as the image expanding unit 34. In the first to fourth embodiments described heretofore, two values of “−1, 0” and two codes are assigned, as shown in Tables 1 and 2, as the magnitude range of a prediction error corresponding to “0” in a prediction error group (based on the grouping of prediction errors) indicative of the magnitude range of a prediction error in Tables 5 and 6, among Tables 1 to 6 contained in the prediction error encoding unit.

In contrast, if the group No. of a prediction error group (“pgrp”) one pixel earlier is small (for example, in the case of the prediction error group No. one pixel earlier being 0 to 3), only “0” is assigned as the magnitude range of a prediction error corresponding to “0” in the prediction error group of a current pixel, as shown in FIG. 7. Consequently, one value, i.e., one code is assigned to “0” in the prediction error group. As a result, the magnitude range of a prediction error corresponding to prediction error group “1” is “−1, 1”, the magnitude range of a prediction error corresponding to prediction error group “2” is “−3 to −2, 2 to 3”, and the magnitude range of a prediction error corresponding to prediction error group “3” is “−7 to −4, 4 to 7”, . . . , and so on, whereby each magnitude range is defined as a bilaterally-symmetric numerical array.

On the other hand, if the group No. of a prediction error group (“pgrp”) one pixel earlier is large (in the case of the prediction error group No. one pixel earlier being 4 or larger), the magnitude range of a prediction error corresponding to each group of the prediction error groups of the current pixel is the same as those shown in Tables 1 and 2, whereby the magnitude range is defined as a bilaterally-asymmetric numerical array.

If a mode in which only “0” is assigned is provided, as shown in Table 7, the code length is shortened as much. In practice, the magnitude range of the prediction error of the current pixel is very likely to be 0, if a prediction error one pixel earlier is small. It is therefore effective to provide such a mode. Under the condition in which the prediction error of the current pixel frequently becomes 0, as described above, it is possible to improve encoding efficiency by assigning a single code to the prediction error group 0 of the current pixel.

Table 8 shows information on the number of overhead bits and overhead bit data when a single code is assigned to the prediction error group 0 of the current pixel, as shown in Table 7. If “0” is assigned to prediction error group 0, the overhead bits are specified as 0.

TABLE 7

| Prediction error | Prediction error groups | | Prediction error groups 4 | |
|---|---|---|---|---|
| group | 0 to 3 one pixel earlier | | and higher one pixel earlier | |
| 0 | | 0 | −1 | 0 |
| 1 | −1 | 1 | −2 | 1 |
| 2 | −3 to −2 | 2 to 3 | −4 to −3 | 2 to 3 |
| 3 | −7 to −4 | 4 to 7 | −8 to −5 | 4 to 7 |
| 4 | −15 to −8 | 8 to 15 | −16 to −9 | 8 to 15 |
| 5 | −31 to −16 | 16 to 31 | −32 to −17 | 16 to 31 |
| 6 | −63 to −33 | 32 to 63 | −64 to −33 | 32 to 63 |
| 7 | −128 to −64 | 64 to 127 | −128 to −65 | 64 to 127 |

TABLE 8
8-bit input

| Prediction error | Binary representation of | Number of | Overhead |
|---|---|---|---|
| group | prediction error | overhead bits | bit data |
| 0 | 0000 0000 | 0 | 0 |
| 1 | SSSS SSSN | 1 | S |
| 2 | SSSS SSNf | 2 | Sf |
| 3 | SSSS SNef | 3 | Sef |
| 4 | SSSS Ndef | 4 | Sdef |
| 5 | SSSN cdef | 5 | Scdef |
| 6 | SSNb cdef | 6 | Sbcdef |
| 7 | 01ab cdef | 7 | 0abcdef |
| | 10ab cdef | 8 | 10abcdef |
| | 1111 1111 | 2 | 11 |

A value of 1 is subtracted from data after difference calculation, if the data is negative.
“S” denotes a positive sign bit and
“N” denotes bit-inverted data.

TABLE 9
Input image: Each color signal (Y, Cb or Cr) has 10 bits
(Lossless compression)

| Mode | 10 bit DPCM | 8-bit CPCM + Fixed 2 bits |
|---|---|---|
| 4:4:4 | bit/pel | bit/pel |
| Y | 7.57 | 7.58 |
| Cb/Cr | 6.64 | 6.68 |
| total | 20.85 | 20.95 |

pel: Pixel

Next, advantages provided by the embodiments of the present invention will be described with reference to Table 9.

Table 9 shows one example of comparing compression code quantities under the condition of lossless compression of the same image between the content (10-bit DPCM) described in Japanese Patent Application No. 2007-180181 applied for a patent by the applicant of the present application to the Japanese Patent Office on Jul. 9, 2007 (U.S. patent application Ser. No. 12/169847 applied for a patent to the U.S. Patent Office on Jul. 9, 2008) and the content of the application filed this time (8-bit DPCM+fixed 2 bits).

The term 10-bit DPCM refers to a mode in which the entirety of 10-bit data supplied to an encoding-side image compression apparatus as input pixel data is DPCM-processed to calculate a prediction error, and the prediction error is encoded by a prediction error encoding unit and output to the reproduction side (image expansion apparatus) as variable-length encoded data.

The term 8-bit DPCM+fixed 2 bits refers to a mode in which 8 bits of 10-bit data supplied to an encoding-side image compression apparatus as input pixel data is DPCM-processed as higher-order bits to calculate a prediction error, and the prediction error is encoded by a prediction error encoding unit as variable-length encoded data, while concurrently multiplexing the remaining 2 bits of the 10-bits data directly with the abovementioned variable-length encoded data by the prediction error encoding unit and outputting the multiplexed data.

Output bit quantities were evaluated for the cases of 10-bit DPCM and 8-bit DPCM+fixed 2 bits, after encoding and compressing data composed of a total of 30 bits, i.e., 10 bits each of three signal components Y, Cb and Cr composing one pixel, using compression-encoding simulation software. In the case of 10-bit DPCM, the result was obtained that the 10 bits of the Y component were compressed to 7.57 bits, each 10 bits of the Cb and Cr components were compressed to 6.64 bits, and thus a total of 30 bits were compressed to 20.85 bits. In the case of 8-bit DPCM+fixed 2 bits, the result was obtained that the 10 bits of the Y component were compressed to 7.58 bits, each 10 bits of the Cb and Cr components were compressed to 6.68 bits, and thus a total of 30 bits were compressed to 20.95 bits. As far as the amount of compressively-encoded one-pixel data is compared between the cases of 10-bit DPCM and 8-bit DPCM+fixed 2 bits, it can be said that there is virtually no difference in encoding efficiency between the two cases. On the other hand, when 10-bit DPCM is performed, a large table is required for the prediction error encoding unit in response to 10-bit DPCM. In contrast, the mode “8-bit DPCM+fixed 2 bits” offers the advantage that only a small table is required for 8-bit DPCM and that encoding can be performed at high speeds.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image compression apparatus comprising:
a setting unit configured to set an input pixel valid-bit-number;
a predictive pixel value generating unit configured to refer to a plurality of higher-order bits of earlier already-input pixel data to generate a predictive pixel value for a plurality of higher-order bits of a new input pixel;
a prediction error group detecting unit configured to detect a prediction error group indicative of the magnitude range of a difference between the predictive pixel value and a value of the plurality of higher-order bits of the new input pixel;
a prediction error encoding unit configured to multiplex variable-length-encoded information indicative of the prediction error group, overhead bits indicative of a specific value within the prediction error group, and lower-order input pixel bits appropriate for the input pixel valid-bit-number; and
a packing unit configured to output data multiplexed by the prediction error encoding unit in units of a predetermined number of bits.

2. The image compression apparatus according to claim 1, further comprising:
a target code quantity difference level detecting unit provided in a stage behind the packing unit or the prediction error encoding unit, in order to detect a target code quantity difference level indicative of the extent of excess of an output code quantity against a target code quantity corresponding to the number of already-encoded pixels;
an error level detecting unit provided in a stage followed by the prediction error group detecting unit, in order to detect an error level indicative of the magnitude level of a difference between a plurality of higher-order bits of the corrected output data of an input pixel one pixel earlier and a plurality of higher-order bits of input pixel data;
an input pixel value correcting unit configured to make a replacement correction to lower-order bits within the plurality of higher-order bits of the input pixel data, so that the lower-order bits are the same as bit data corresponding to a corrected output pixel value one pixel earlier, according to the target code quantity difference level and the error level; and
a prediction error calculating unit configured to calculate a prediction error which is a difference between corrected input pixel data sent from the input pixel value correcting unit and a predictive pixel value sent from the predictive pixel value generating unit;
wherein the prediction error encoding unit excludes the lower-order bit data of overhead bits of the prediction error and lower-order input pixel bits appropriate for the input pixel valid-bit-number from the objects of encoding, according to the prediction error group and the target code quantity difference level, before encoding the prediction error.

3. The image compression apparatus according to claim 2, further comprising a correcting data storing unit connected to the higher-order bit line and the lower-order bit line of input pixel data, so that when the lower-order bit data within the plurality of higher-order bits are subjected to replacement correction, the correcting data storing unit stores as many pre-replacement data items as the number of the replaced bits, on the basis of information from the input pixel value correcting unit and, for the lower-order input pixel bits, the correcting data storing unit stores data on the lower-order bits excluded from the objects of encoding,
wherein the packing unit packs and outputs pre-replacement lower-order bit data within the replaced plurality of higher-order bits sent from the correcting data storing unit and the data on the lower-order bits not included in the objects of encoding, up to the amount of code quantity left over as a result of the capacity of a memory unit having the unit of fixed length setting being not filled up, after the completion of packing the output data of the prediction error encoding unit.

4. The image compression apparatus according to claim 1, wherein the prediction error encoding unit includes a storing unit configured to store prediction error group information one pixel earlier indicative of a group to which the magnitude of a prediction error one pixel earlier belongs, in order to switch the variable-length code table of group information indicative of the group to which the magnitude of the prediction error belongs, according to the prediction error group information one pixel earlier.

5. The image compression apparatus according to claim 2, wherein the error level detecting unit includes:
an adder configured to find a difference between an input pixel value and the predictive pixel value sent from the predictive pixel value generating unit; and
a level detecting unit configured to output an error level appropriate for the magnitude of the difference sent from the adder;
wherein the input pixel value correcting unit includes an LSB (less significant bits)-side correcting unit configured to correct the lower-order bit data within the plurality of higher-order bits of the input pixel data, according to a combination of an error level output from the error level detecting unit and a target code quantity difference level output from the target code quantity difference level detecting unit, so that the data is the same as the lower-order bit data of the predictive pixel value sent from the predictive pixel value generating unit.

6. The image compression apparatus according to claim 2, wherein the prediction error encoding unit includes:
a bit length detecting unit configured to detect prediction error group information indicative of a group to which the magnitude of the prediction error belongs, according to a prediction error input from the prediction error calculating unit, output the information to a later-described variable-length code table, and detect the number of overhead bits of the information, wherein if the group is a prediction error group in which the magnitude of the prediction error is greater than a predetermined value, then the bit length detecting unit detects the number of reduced bits of the overhead bits appropriate for the target code quantity difference level input from the target code quantity difference level detecting unit through a one-clock delaying unit, and outputs a total code length obtained by subtracting the number of bits to be reduced from the sum of a variable-length code length received from the variable-length code table and the number of overhead bits to a one-clock delaying unit;
a variable-length encoding table configured to output the length of a variable-length code and the variable-length code appropriate for the prediction error group information received from the bit length detecting unit to a later-described selector, and output the length of the variable-length code to the bit length detecting unit; and
a selector configured to select the variable-length code received from the variable-length encoding table and overhead bit data on the basis of the variable-length code received from the variable-length encoding table and the prediction error group information received from the bit length detecting unit, and output the data as serial data.

7. The image compression apparatus according to claim 1, wherein the packing unit outputs output data sent from the prediction error encoding unit in units of the number of bits twice or more as large as a set average code quantity.

8. The image compression apparatus according to claim 2, wherein the target code quantity difference level detecting unit performs the calculation of a difference between the set average code quantity and the output code quantity of the packing unit and the cumulative calculation of the results of the differential calculation using a single adder, in order to determine a target code quantity difference level by nonlinearly quantizing the result of the cumulative calculation.

9. The image compression apparatus according to claim 2, wherein the target code quantity difference level detecting unit includes:
an adder configured to add a set average code quantity and target code quantity difference information one clock earlier retained by a one-clock delaying unit, subtract the number of output bits from the result of the addition if output byte count information from the packing unit is valid, and output the result of the subtraction through the one-clock delaying unit as target code quantity difference information; and
a quantizing unit, to which the target code quantity difference information output from the one-clock delaying unit is input, thereby performing quantization appropriate for the target code quantity difference information and outputting the result of the quantization as a target code quantity difference level.

10. An image expansion apparatus comprising:
a setting unit configured to set an output pixel valid-bit-number;
an encoded data loading unit configured to load the variable-length code of a prediction error group indicative of the magnitude range of a prediction error, overhead bits indicative of the value of the prediction error, and data encoded using lower-order bits appropriate for the output pixel valid-bit-number;
a prediction error decoding unit configured to reproduce lower-order bits appropriate for the prediction error and the output pixel valid-bit-number out of the data loaded by the encoded data loading unit;
a predictive pixel value generating unit configured to refer to a plurality of higher-order bits of an earlier already-reproduced pixel to generate a predictive pixel value; and
a pixel value reproducing unit configured to add the reproduced prediction error to the predictive pixel value to reproduce the pixel value of a plurality of higher-order bits.

11. The image expansion apparatus according to claim 10, further comprising a target code quantity difference level detecting unit configured to detect a target code quantity difference level indicative of the extent of excess of an already-decoded code quantity against a target code quantity corresponding to the number of already-reproduced pixels,
wherein the prediction error decoding unit reproduces the overhead bits indicative of the value of the prediction error and the lower-order bits appropriate for the output pixel valid-bit-number as 0, on the basis of the target code quantity difference level and the prediction error group.

12. The image expansion apparatus according to claim 10, further comprising:
a reproduced data loading unit, to which information on the start-of-loading position of correcting data following encoded data is supplied at the timing of the completion of loading the encoded data by the encoded data loading unit, so that the reproduced data loading unit loads the correcting data by separating the correcting data from the encoded data at a precise data position on the basis of the start-of-loading position information; and
a correction processing unit configured to correctively restore lower-order bit data within a plurality of higher-order bits of an input pixel before correction at the time of encoding and lower-order bit data excluded from the objects of encoding, using the correcting data, thereby correcting the decoded and reproduced data.

13. The image expansion apparatus according to claim 10, wherein the prediction error decoding unit includes a storing unit configured to store prediction error group information one pixel earlier indicative of a group to which the magnitude of a prediction error one pixel earlier belongs, in order to switch the variable-length decoding table of group information indicative of the group to which the magnitude of the prediction error belongs, according to the prediction error group information one pixel earlier.

14. The image expansion apparatus according to claim 10, wherein the encoded data loading unit loads the variable-length encoded data in units of the number of bits twice or more as large as the set average code quantity.

15. The image expansion apparatus according to claim 11, wherein the target code quantity difference level detecting unit performs the calculation of a difference between the set average code quantity and a code quantity loaded by the encoded data loading unit and the cumulative calculation of the results of the differential calculation using a single adder, in order to determine a target code quantity difference level by nonlinearly quantizing the result of the cumulative calculation.

16. The image expansion apparatus according to claim 10, wherein the encoded data loading unit includes:
first and second selectors configured to receive compressively-encoded data as an input, in order to load the data sequentially to first and second one-clock delaying units for each one clock during a period in which information on the number of bytes to be loaded is valid or retain data already loaded to the first and second one-clock delaying units during a period in which the information on the number of bytes to be loaded is invalid;
a third selector configured to make a cue search of encoded data retained in the first and second one-clock delaying units for a variable-length code at a stage one pixel earlier, as one serial data item, on the basis of information on the result of accumulating the number of bits of a variable-length code decoded until two pixels earlier which is less than the number of bytes to be loaded;
a fourth selector configured to receive data output from the third selector as an input and make a cue search of the next decoded pixel for a variable-length code on the basis of the number of bits of encoded data one pixel earlier sent from a variable-length code decoding table within the prediction error decoding unit; and
an adder configured to add code length data input from the variable-length code decoding table and a predetermined number of lower-order bits of an accumulation result one clock earlier retained in a third one-clock delaying unit, and output data composed of a predetermined number of lower-order bits+1 bit, including carry bits, to the third one-clock delaying unit.

17. The image expansion apparatus according to claim 10, wherein the prediction error decoding unit includes:
a fourth one-clock delaying unit configured to cause a one-clock delay in variable-length encoded data output from the encoded data loading unit;
a decoding table configured to receive variable-length encoded data sent from the fourth one-clock delaying unit as an input, decode information on a prediction error group indicative of the magnitude of a prediction error and the code length thereof, reproduce the number of overhead bits used to indicate a specific value of the prediction error within the group on the basis of the group information and, if the prediction error is larger than a predetermined value, reproduce the number of reduced bits of the number of overhead bits according to the target code quantity difference level detected by the target code quantity difference level detecting unit on the basis of the group information, thereby generating a total number of bits obtained by subtracting the number of reduced bits from a sum of the code length of the group information and the number of overhead bits; and
a fifth selector configured to remove the encoded data of group information from among data output from the fourth one-clock delaying unit on the basis of the code length of the group information obtained as a result of decoding using the variable-length code decoding table, extract and perform code expansion processing on overhead bit data on the number of overhead bits, and substitute the lower-order bit data of the number of reduced bits, among the overhead bit data, with 0.

18. The image expansion apparatus according to claim 11, wherein the target code quantity difference level detecting unit includes:
a fifth one-clock delaying unit to which information on the number of loaded bytes generated at the encoded data loading unit is input at a point in time except a period of a predetermined number of clocks for initial data loading, wherein the fifth one-clock delaying unit is configured to supply the information as an already-decoded code quantity in units of a predetermined code quantity, to the negative input end of a later-described adder with a one-clock delay;
an adder configured to receive a set average code quantity as one input, add the input set average code quantity to an accumulation result one clock earlier retained by a sixth one-clock delaying unit, subtract a predetermined code quantity from the result of accumulating the set average code quantity each time a one-bit signal indicative of the predetermined code quantity is input from the fifth one-clock delaying unit, and output the result of the subtraction through the sixth one-clock delaying unit as target code quantity difference information; and
a quantizing unit configured to receive target code quantity difference information output from the sixth one-clock delaying unit as an input, perform the same predetermined quantization on the target code quantity difference information as is performed on the encoding apparatus side, and output the quantized information as a target code quantity difference level.

19. An image processing apparatus comprising:
a pixel compressing unit provided with an image compression apparatus including: a setting unit configured to set an input pixel valid-bit-number; a predictive pixel value generating unit configured to refer to a plurality of higher-order bits of earlier already-input pixel data to generate a predictive pixel value for a plurality of higher-order bits of a new input pixel; a prediction error group detecting unit configured to detect a prediction error group indicative of the magnitude range of a difference between the predictive pixel value and a value of the plurality of higher-order bits of the new input pixel; a prediction error encoding unit configured to multiplex variable-length-encoded information indicative of the prediction error group, overhead bits indicative of a specific value within the prediction error group, and lower-order input pixel bits appropriate for the input pixel valid-bit-number; and a packing unit configured to output data multiplexed by the prediction error encoding unit in units of a predetermined number of bits;
a pixel expanding unit provided with an image expanding apparatus including: a setting unit configured to set an output pixel valid-bit-number; an encoded data loading unit configured to load the variable-length code of a prediction error group indicative of the magnitude range of a prediction error, overhead bits indicative of the value of the prediction error, and data encoded using lower-order bits appropriate for the output pixel valid-bit-number; a prediction error decoding unit configured to reproduce lower-order bits appropriate for the prediction error and the output pixel valid-bit-number out of the data loaded by the encoded data loading unit; a predictive pixel value generating unit configured to refer to a plurality of higher-order bits of an earlier already-reproduced pixel to generate a predictive pixel value; and a pixel value reproducing unit configured to add the reproduced prediction error to the predictive pixel value to reproduce the pixel value of a plurality of higher-order bits; and
an image processing unit configured to temporarily store an intermediate processing result obtained by processing input image data in an external memory unit through the pixel compressing unit, read a plurality of intermediate processing results stored in the external memory unit through the pixel expanding unit, and output an image-processed final processing result.
